(19) United States
(12) Patent Application Publication
(10) Pub. No.: US 2025/0086164 A1
(43) Pub. Date: Mar. 13, 2025

(54) METHODS AND SYSTEMS FOR ASSESSING CHROMATOGRAPHIC COLUMN INTEGRITY

(71) Applicant: Regeneron Pharmaceuticals, Inc., Tarrytown, NY (US)

(72) Inventors: Manoj GANESH, Clifton Park, NY (US); Zizhao LIU, Delmar, NY (US)

(73) Assignee: Regeneron Pharmaceuticals, Inc., Tarrytown, NY (US)

(21) Appl. No.: 18/826,300

(22) Filed: Sep. 6, 2024

Related U.S. Application Data
(60) Provisional application No. 63/581,302, filed on Sep. 8, 2023.

(51) Int. Cl. G06F 16/23; G06F 16/22

(52) U.S. Cl. CPC G06F 16/2365; G06F 16/221

(57) ABSTRACT

A method for assessing chromatographic column integrity may include introducing acetone into a chromatographic column and measuring absorbance values of an eluate of the chromatographic column. The method for assessing chromatographic column integrity may also include generating a first data structure based on the absorbance values, implementing a fitting algorithm based on the first data structure to generate a transition function, generating a second data structure based on the transition function, and generating a transition plot based on the first and second data structures, wherein the transition plot includes transition plot-related data. A value of a performance parameter may be generated based on the transition plot-related data.

### CROSS-REFERENCE TO RELATED APPLICATIONS

This application claims priority to U.S. Provisional Patent Application No. 63/581,302, filed on Sep. 8, 2023, which is hereby incorporated by reference in its entirety.

### FIELD OF DISCLOSURE

Aspects of the present disclosure relate generally to chromatography systems and methods. In particular, the present disclosure relates to systems and methods for assessing chromatographic column integrity prior to column use in processes related to biological production of therapeutics.

### INTRODUCTION

Biopharmaceutical products (e.g., antibodies, fusion proteins, adeno-associated viruses (AAVs), proteins, tissues, cells, polypeptides, or other therapeutic products of biological origin) are increasingly being used in the treatment and prevention of infectious diseases, genetic diseases, autoimmune diseases, and other ailments. Production of the biopharmaceutical products requires chromatography to purify, characterize, and validate the products. Disruptions in the functionality of a chromatography system, for example, diminishment of chromatographic column integrity, can affect the purity of biopharmaceutical products produced using chromatography. Due to the narrow tolerances required for biopharmaceutical product manufacture, even partial loss of chromatographic column integrity can render all product that contacts the compromised column unusable.

Conventional methods of assessing column integrity may require biopharmaceutical products that cannot be included in a therapeutic after being used to assess column integrity. Even small amounts of such product, for example, on the scale of micrograms, may incur significant costs. In other examples, assessing column integrity, with or without using biopharmaceutical products, may not be possible because of certain characteristics of a chromatographic column.

### SUMMARY

Aspects of the present disclosure relate to a method for assessing chromatographic column integrity. The method may include introducing acetone into a chromatographic column. The method may include measuring absorbance values of an eluate of the chromatographic column. The method may include generating a first data structure based on the absorbance values. The method may include implementing a fitting algorithm based on the first data structure to generate a transition function. The method may include generating a second data structure based on the transition function. The method may further include generating a transition plot based on the first and second data structures, wherein the transition plot includes transition plot-related data. The method may also include generating a value of a performance parameter based on the transition plot-related data.

The chromatographic column may have a column volume of about 50 μL to about 600 μL. The chromatographic column may be a first chromatographic column, the value of the performance parameter may correspond to a column integrity of the first chromatographic column, and the method may further include simultaneously generating a second value of the performance parameter corresponding to a column integrity of a second chromatographic column. The performance parameter may be a non-Gaussian height equivalent of a theoretical plate (NG-HETP). The performance parameter may be a skew. The transition function may include a cumulative distribution function. The transition function may include a sigmoid function. The sigmoid function may be a five-parameter sigmoid function.

In another aspect, the present disclosure is directed to of developing a pre-use assessment protocol. The method may include performing a first chromatography operation using a first chromatographic column. The first chromatography operation of the method may include introducing a first volume of tracing agent to the chromatographic column, wherein the first volume of tracing agent includes a first concentration of the tracing agent. The first chromatography operation may include measuring a first set of absorbance values of an eluate of the first chromatography operation. The first chromatography operation may further include generating a first data structure based on the first absorbance values. The first chromatography operation may include implementing a first fitting algorithm based on the first data structure to generate a first transition function. In addition, the method may further include determining a first coefficient of correlation corresponding to the first transition function. The method may include performing a second chromatography operation using the first chromatographic column or a second chromatographic column. The second chromatography operation of the method may include introducing a second volume of tracing agent to the chromatographic column, wherein the second volume of tracing agent includes a second concentration of the tracing agent. The second chromatography operation may include measuring a second set absorbance values of an eluate of the second chromatography operation, wherein the second set of absorbance values includes a different number of absorbance values than the first set of absorbance values. The second chromatography operation may include generating a second data structure based on the second absorbance values. The second chromatography operation may include implementing a second fitting algorithm based on the second data structure to generate a second transition function. The second chromatography operation may also include determining a second coefficient of correlation corresponding to the second transition function. The method may further include comparing the first coefficient of correlation to the second coefficient of correlation. The method may also include determining, based on the comparison of the first coefficient of correlation to the second coefficient of correlation, a third volume of tracing agent, a third concentration of the tracing agent, and a sample size of absorbance measurements.

The third volume may be equal to the first or the second volume, the third concentration may be equal to the first or the second concentration, and/or the sample size of absorbance measurements may be equal to the number of absorbance measurements in the first or the second set of absorbance measurements. The tracing agent may be acetone. The method may further include performing a third chromatography operation. The third chromatography operation may include introducing the third volume of the tracing agent into the first chromatographic column, the second chromatographic column, or a third chromatographic column. The third chromatography operation may include measuring a third set of absorbance values of an eluate of the third chromatography operation. The third set of absorbance measurements may include a number of values equal to the sample size of absorbance measurements. The third chromatography operation may include generating a third data structure based on the absorbance values. The third chromatography operation may include implementing a third fitting algorithm based on the third data structure to generate a third transition function. The third chromatography operation may include generating a fourth data structure based on the third transition function. The third chromatography operation may include generating a transition plot based on the third and fourth data structures, wherein the transition plot includes transition plot-related data. The third chromatography operation may include generating a value of a performance parameter based on the transition plot-related data. The first chromatographic column may have a column volume (CV) of about 50 μL to about 600 μL. The first volume of tracing agent may be about 2 CV to about 5 CV and the second volume of tracing agent may be about to 2 CV to about 5 CV. The first concentration of tracing agent may be about 0.1 vol. % to about 2 vol. % and the second concentration of tracing agent may be about 3 vol. % to about 5 vol. %

In another aspect, the present disclosure is directed to a system for assessing chromatographic column integrity. The system may include a chromatographic column. The system may include an automated fluid handling device. The system may include a detector. The system may include a processor. The system may include a non-transitory computer readable media comprising instructions which, when executed by the processor, causes the processor to perform operations. The operations may include introducing, with the automated fluid handling device, acetone into the chromatographic column. The operations may include measuring, with the detector, an absorbance of an eluate of the chromatographic column. The operations may include generating, with the processor, a first data structure based on the measured absorbance. The operations may include implementing, with the processor, a fitting algorithm based on the first data structure to generate a transition function. The operations may include generating, with the processor, a second data structure based on the transition function. The operations may include generating, with the processor, a transition plot based on the first and second data structures, wherein the transition plot includes transition plot-related data (TPRD). The operations may further include analyzing, with the processor, the transition plot-related data (TPRD) to generate a value of a performance parameter.

The performance parameter may correspond to a column integrity of the chromatographic column. The performance parameter may include a non-Gaussian height equivalent of a theoretical plate (NG-HETP) or a skew. The chromatographic column may have a column volume of about 50 μL to about 600 μL. The chromatographic column may be a first chromatographic column. The system may further include a second chromatographic column. The value of the performance parameter may be a first value of the performance parameter, and the operations further comprise generating a second value of the performance parameter. The first value of the performance parameter may correspond to a column integrity of the first chromatographic column and the second value of the performance parameter corresponds to a column integrity of the second chromatographic column.

### BRIEF DESCRIPTION OF THE DRA WINGS

The accompanying drawings, which are incorporated in and constitute a part of this specification, illustrate various exemplary aspects of the present disclosure, and together with the description, serve to explain the principles of the disclosed examples. Any features of an aspect or example described herein (e.g., composition, formulation, method, etc.) may be combined with any other aspect or example, and all such combinations are encompassed by the present disclosure. Moreover, the described systems and methods are neither limited to any single aspect nor example thereof, nor to any combinations or permutations of such aspects and examples. For the sake of brevity, certain permutations and combinations are not discussed and/or illustrated separately herein.

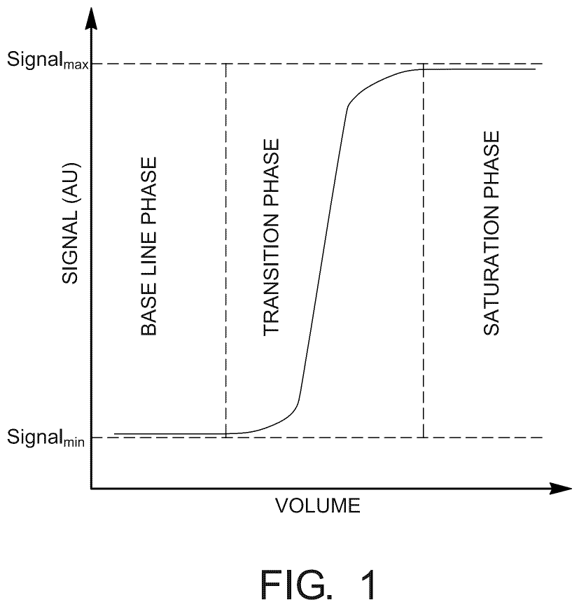

FIG. 1 depicts an exemplary chromatography transition, according to aspects of the present disclosure;

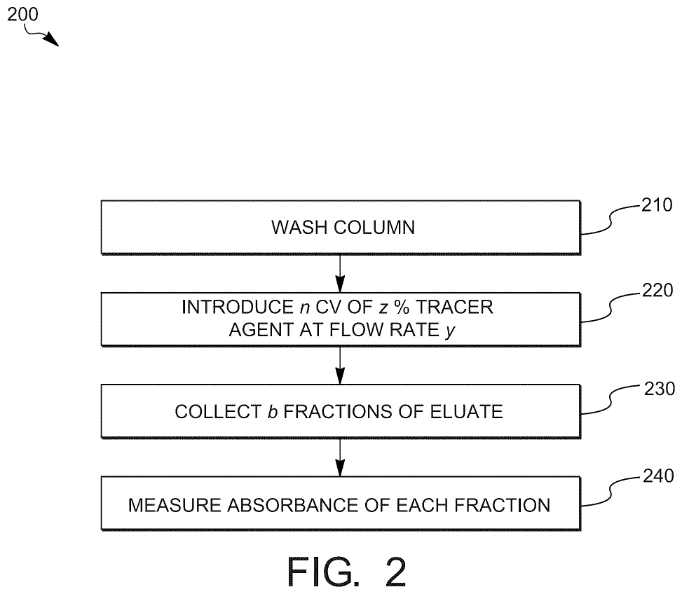

FIG. 2 depicts, in flowchart form, an exemplary process for obtaining measurements to assess chromatographic column integrity, according to aspects of the present disclosure;

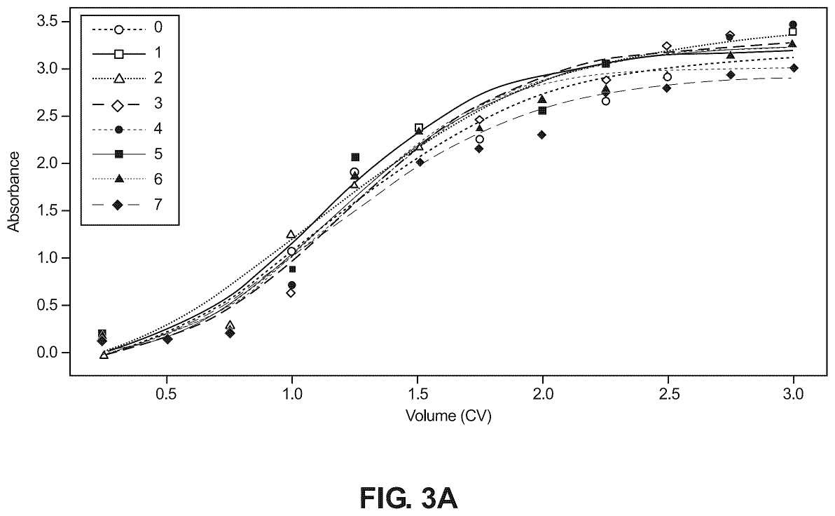

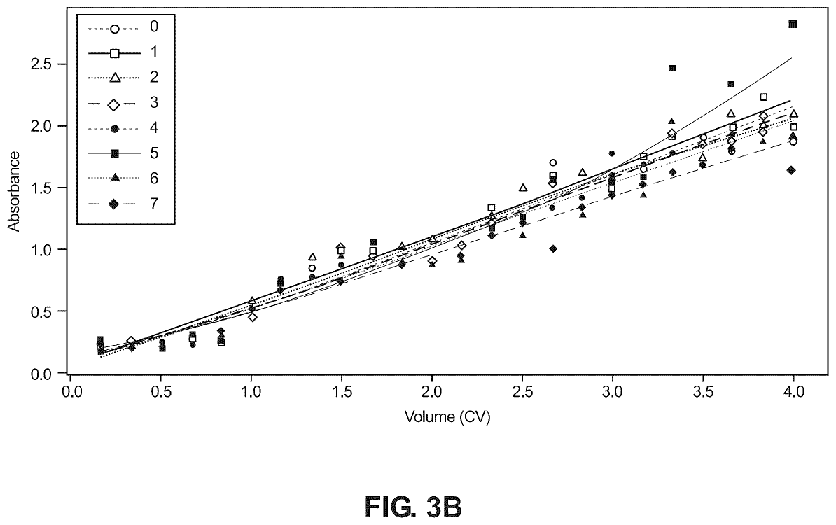

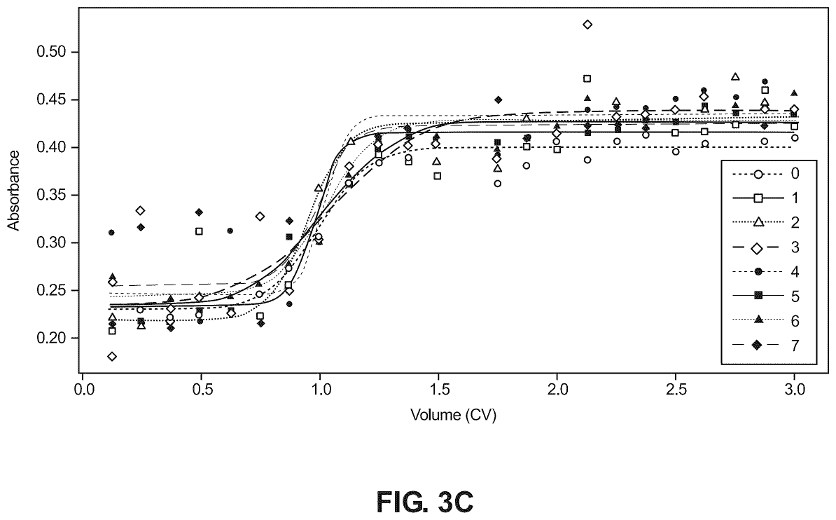

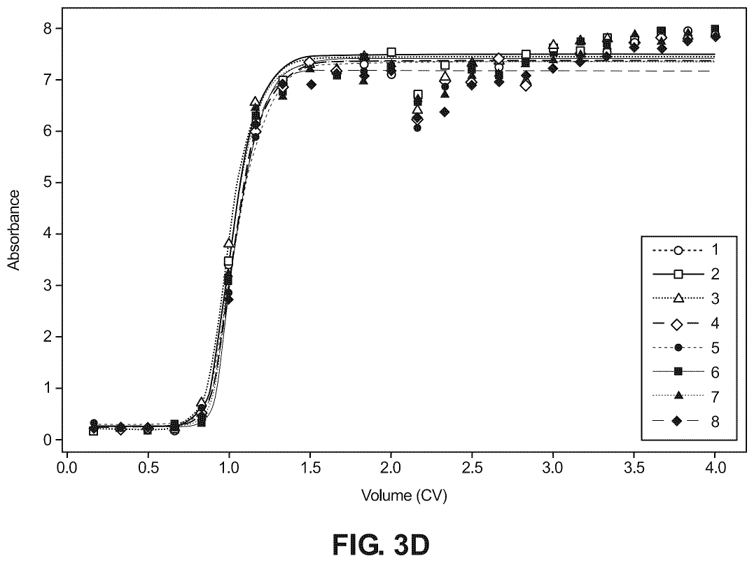

FIGS. 3A-3D show chromatograms including absorbance plotted against a volume passed of a chromatography operation, according to aspects of the present disclosure;

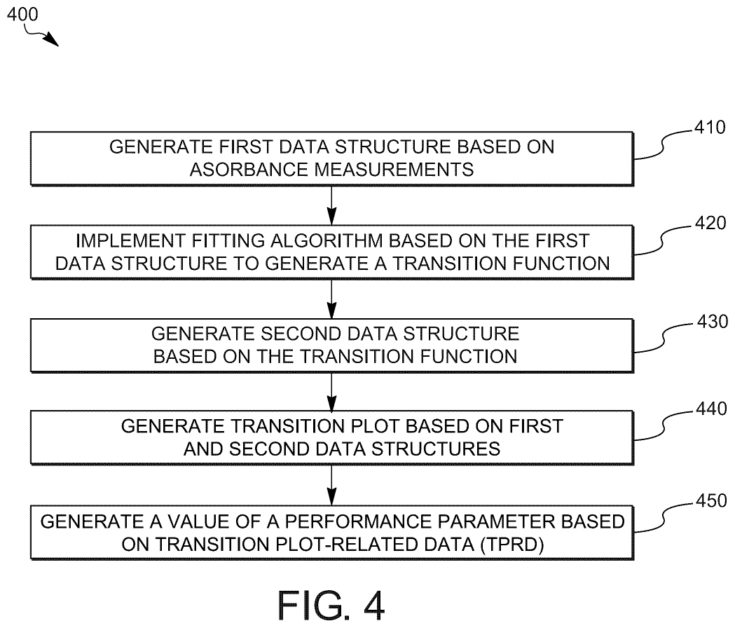

FIG. 4 depicts, in flowchart form, an exemplary process for generating performance parameters relating to a column integrity, according to some aspects of the present disclosure;

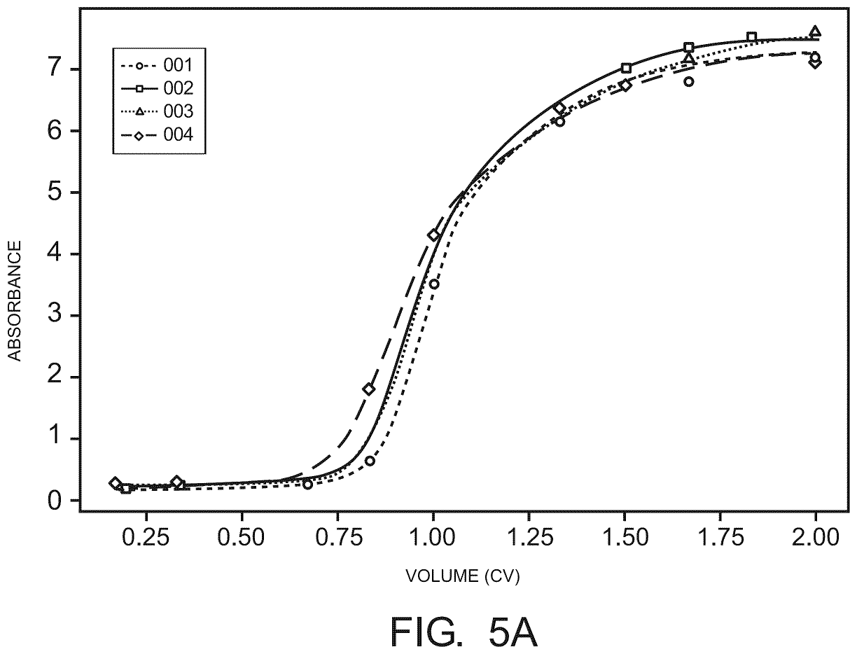

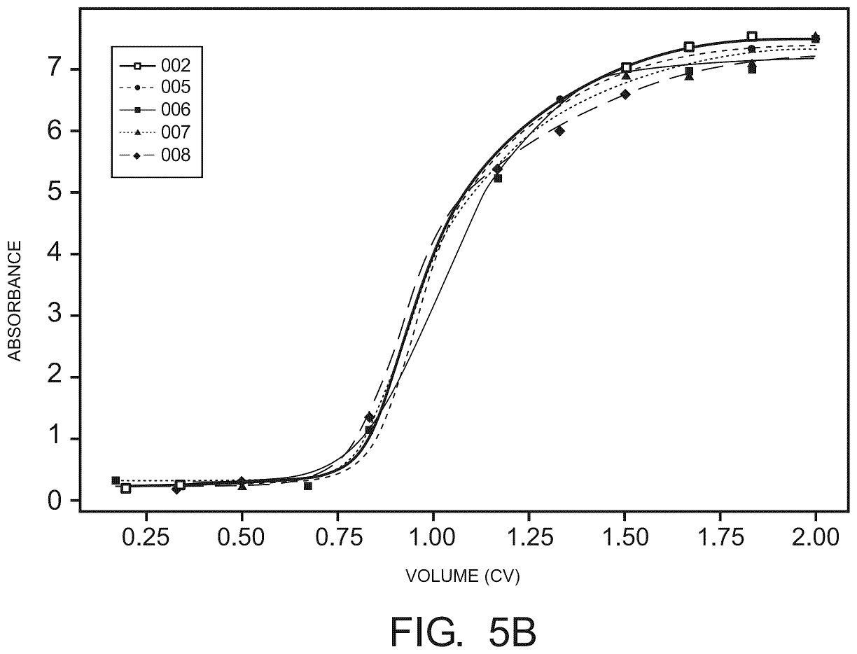

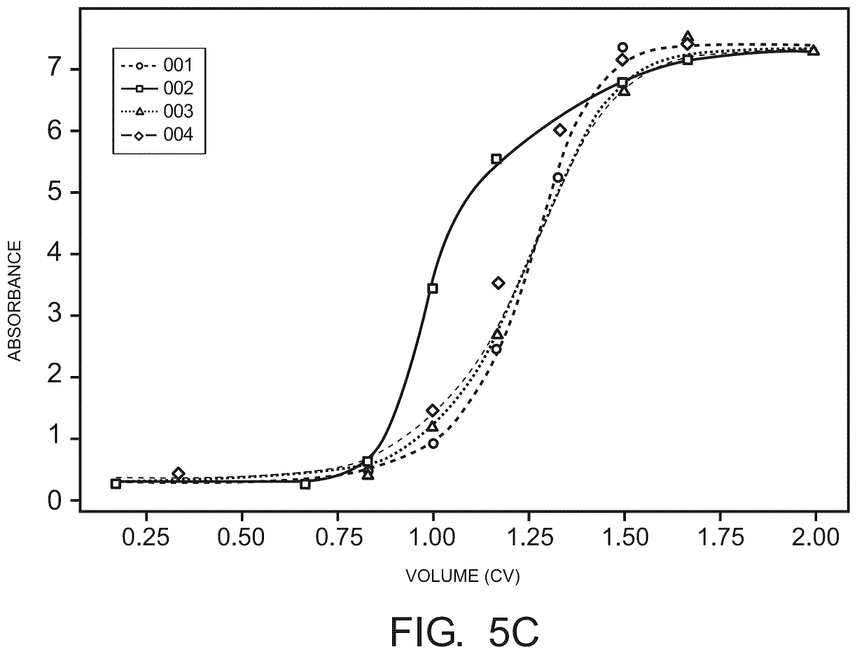

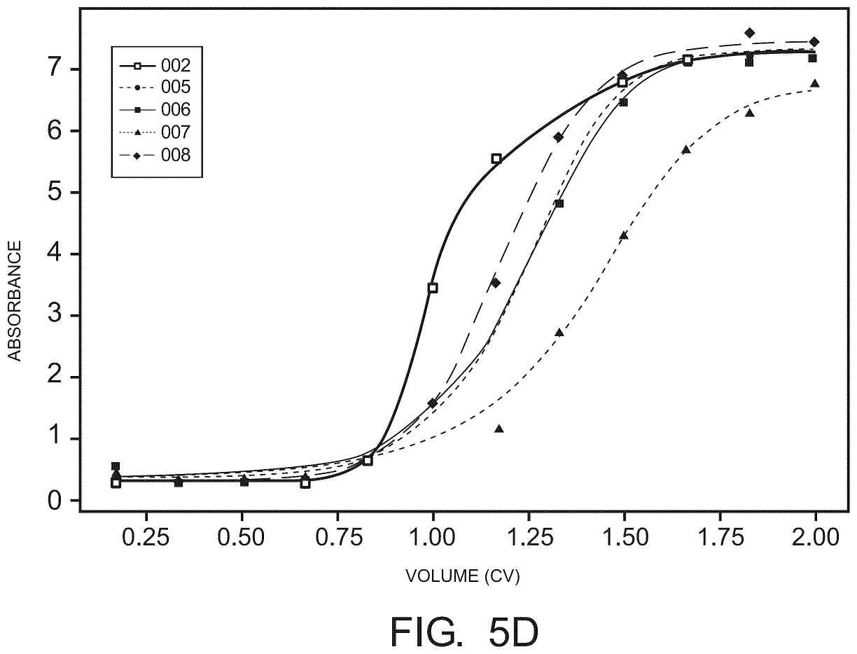

FIGS. 5A-5D show chromatograms including absorbance plotted against a volume passed of a chromatography operation, according to aspects of the present disclosure;

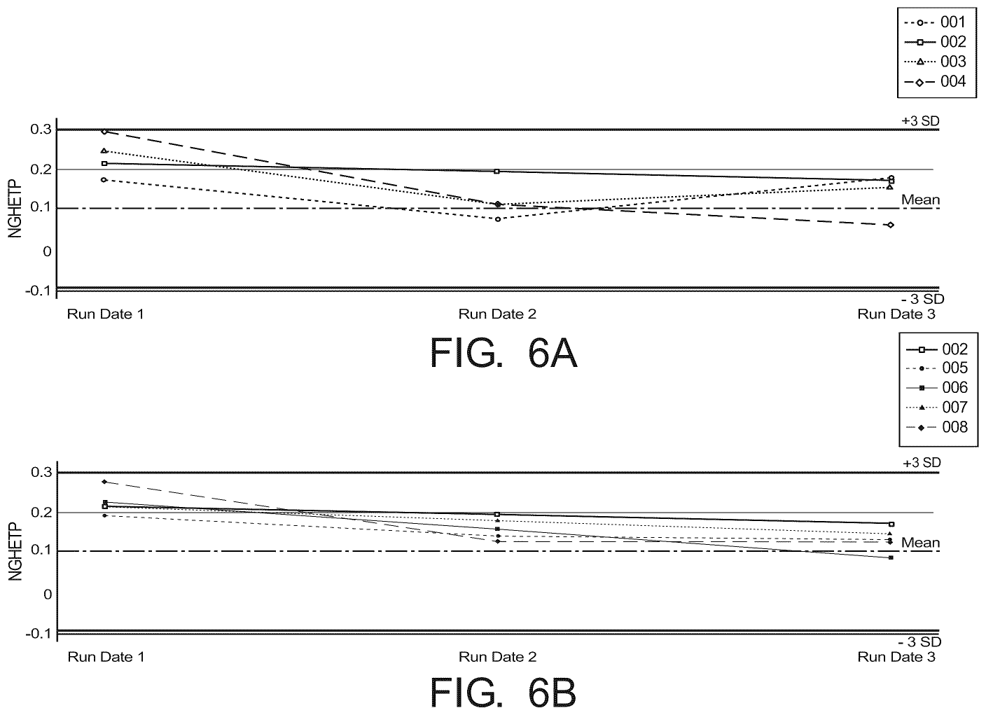

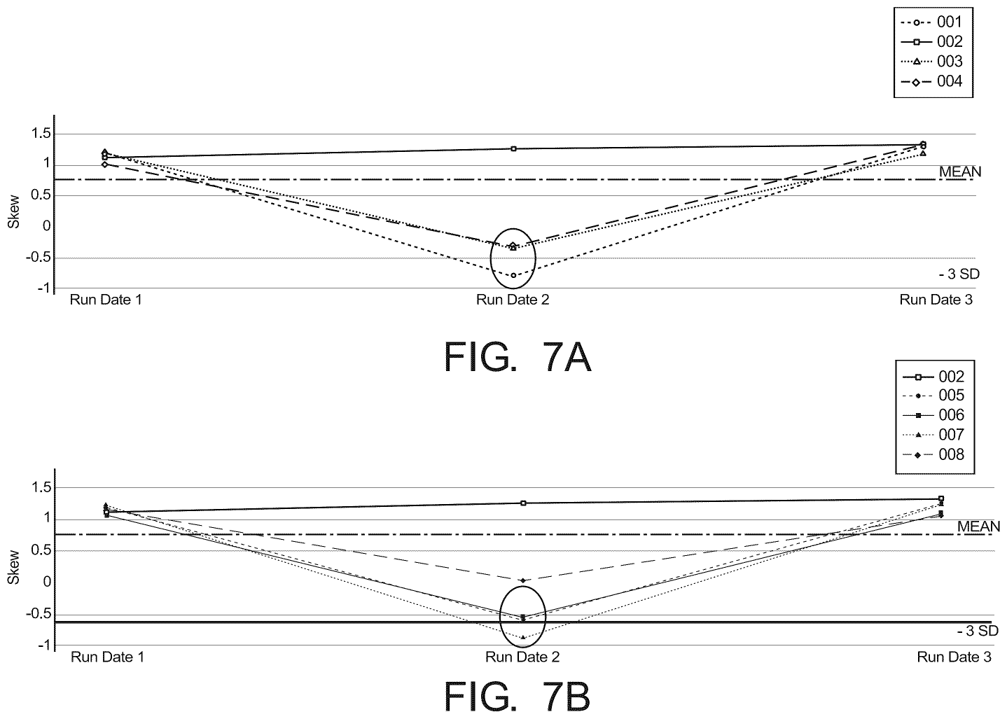

FIGS. 6A, 6B, 7A, and 7B includes charts that illustrate changes in performance parameter values, according to aspects of the present disclosure;

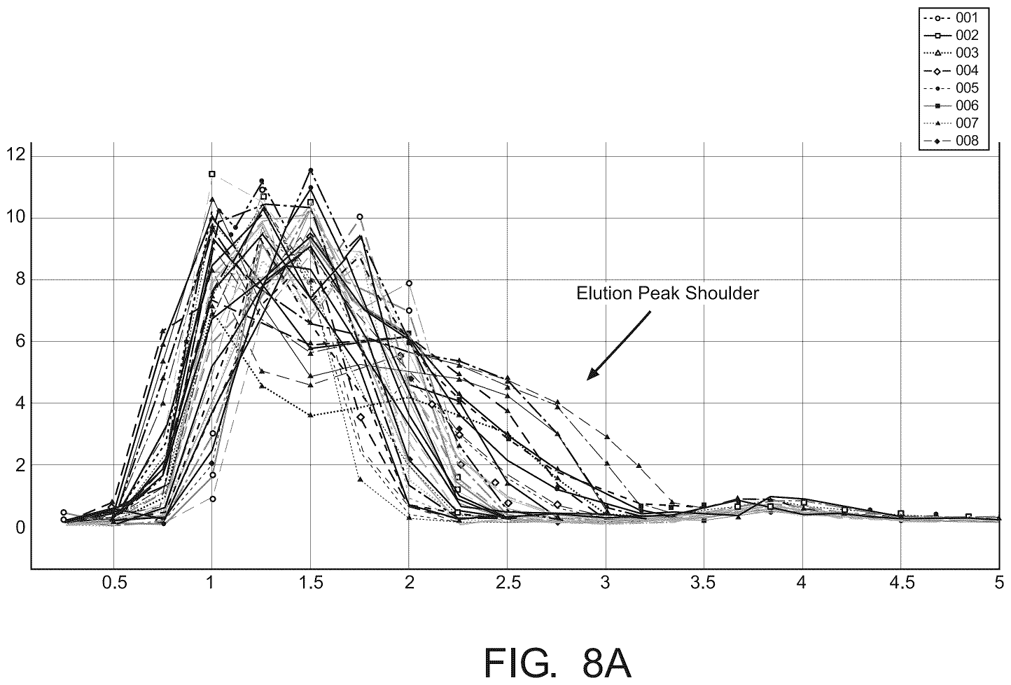

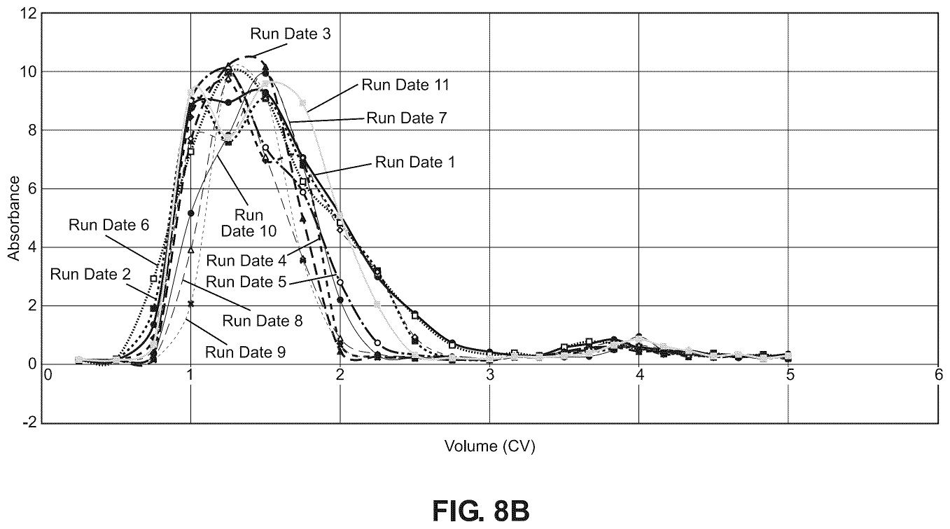

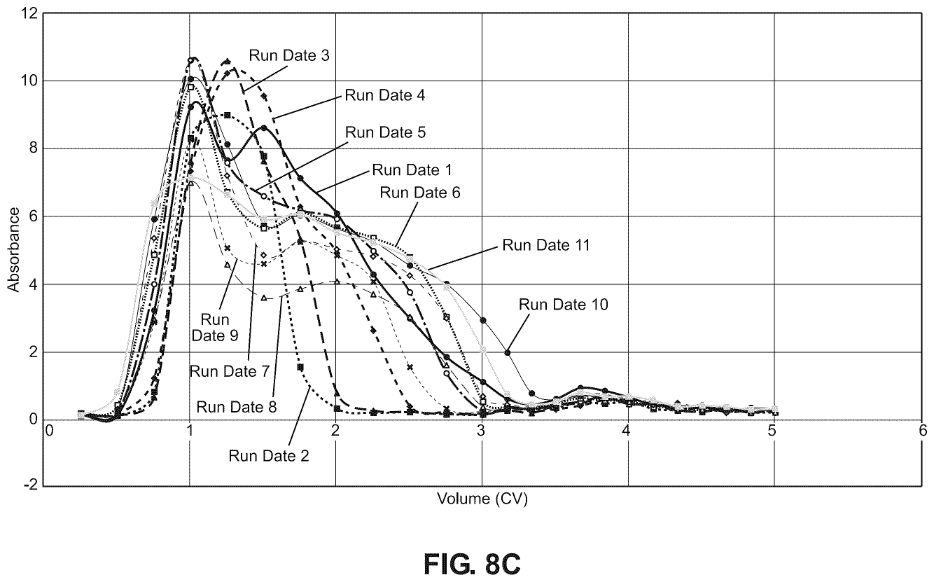

FIG. 8A is an overlay plot including chromatograms for a set of chromatographic columns, according to some aspects of the present disclosure;

FIG. 8B includes chromatograms from the overlay plot of FIG. 8A for one of the chromatographic columns of the set, according to some aspects of the present disclosure;

FIG. 8C includes chromatograms from the overlay plot of FIG. 8A for one of the chromatographic column of the set, according to some aspects of the present disclosure;

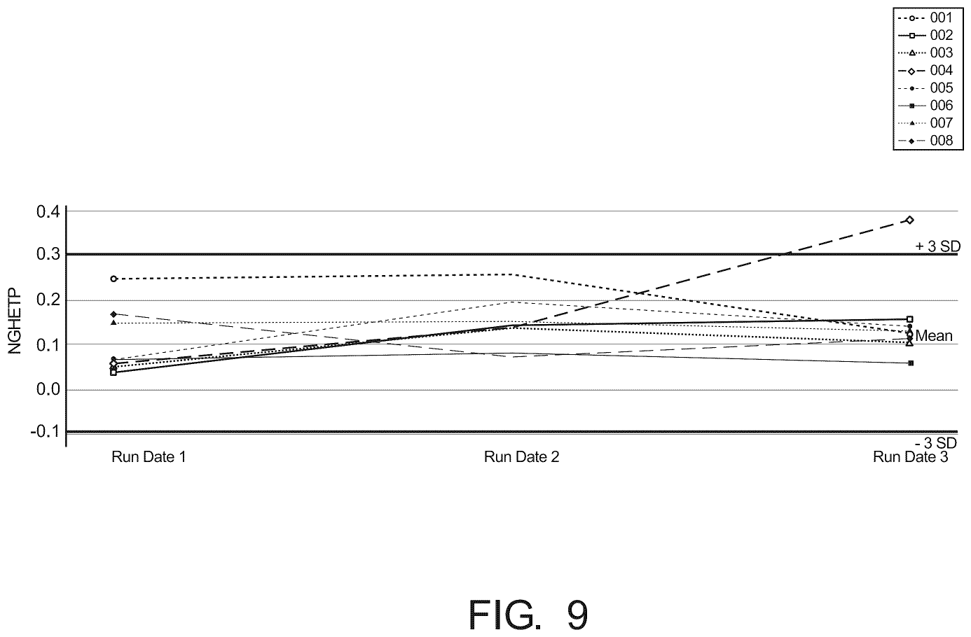

FIG. 9 includes a chart that illustrates changes in performance parameter values, according to aspects of the present disclosure; and

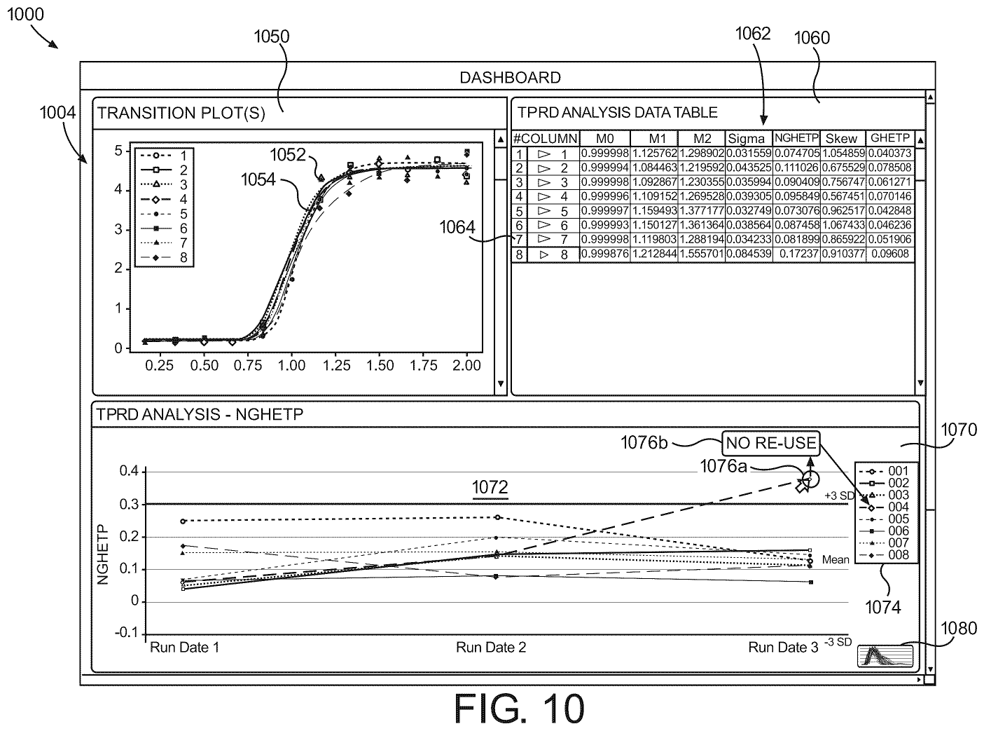

FIG. 10 depicts an exemplary column integrity assessment dashboard, according to aspects of the present disclosure.

### DETAILED DESCRIPTION

Unless defined otherwise, all technical and scientific terms used herein have the same meaning as is commonly understood by one of ordinary skill in the art to which this disclosure belongs. Although any suitable methods and materials (e.g., similar or equivalent to those described herein) can be used in the practice or testing of the present disclosure, particular example methods are now described. All publications mentioned are hereby incorporated by reference.

As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” For the terms “for example” and “such as,” and grammatical equivalences thereof, the phrase “and without limitation” is understood to follow unless explicitly stated otherwise.

As used herein, the term “about” is meant to account for variations due to experimental error. When applied to numeric values, the term “about” may indicate a variation of +/−5% from the disclosed numeric value, unless a different variation is specified. As used herein, the singular forms “a,” “an,” and “the” include plural referents unless the context clearly dictates otherwise. Further, all ranges are understood to be inclusive of endpoints, e.g., from 1 centimeter (cm) to 5 cm would include lengths of 1 cm, 5 cm, and all distances between 1 cm and 5 cm.

It should be noted that all numeric values disclosed or claimed herein (including all disclosed values, limits, and ranges) may have a variation of +/−5% from the disclosed numeric value unless a different variation is specified.

The term “polypeptide” as used herein refers to any amino acid polymer having more than about 20 amino acids covalently linked via amide bonds. Proteins contain one or more amino acid polymer chains (e.g., polypeptides). Thus, a polypeptide may be a protein, and a protein may contain multiple polypeptides to form a single functioning biomolecule.

Post-translational modifications may modify or alter the structure of a polypeptide. For example, disulfide bridges (e.g., S—S bonds between cysteine residues) may be formed post-translationally in some proteins. Some disulfide bridges are essential to proper structure, function, and interaction of polypeptides, immunoglobulins, proteins, co-factors, substrates, and the like. In addition to disulfide bond formation, proteins may be subject to other post-translational modifications, such as lipidation (e.g., myristoylation, palmitoylation, farnesoylation, geranylgeranylation, and glycosylphosphatidylinositol (GPI) anchor formation), alkylation (e.g., methylation), acylation, amidation, glycosylation (e.g., addition of glycosyl groups at arginine, asparagine, cysteine, hydroxylysine, serine, threonine, tyrosine, and/or tryptophan), and phosphorylation (i.e., the addition of a phosphate group to serine, threonine, tyrosine, and/or histidine). Post-translational modifications may affect the hydrophobicity, electrostatic surface properties, or other properties which determine the surface-to-surface interactions participated in by the polypeptide.

As used herein, the term “protein” includes biotherapeutic proteins, recombinant proteins used in research or therapy, trap proteins and other Fc-fusion proteins, chimeric proteins, antibodies, monoclonal antibodies, human antibodies, bispecific antibodies, antibody fragments, antibody-like molecules, nanobodies, recombinant antibody chimeras, cytokines, chemokines, peptide hormones, and the like. A protein of interest (POI) may include any polypeptide or protein that is desired to be isolated, purified, or otherwise prepared. POIs may include polypeptides produced by a cell, including antibodies.

The term “antibody,” as used herein, includes immunoglobulins comprised of four polypeptide chains: two heavy (H) chains and two light (L) chains inter-connected by disulfide bonds. Typically, antibodies have a molecular weight of over 100 kDa, such as between 130 kDa and 200 kDa, such as about 140 kDa, 145 kDa, 150 kDa, 155 kDa, or 160 kDa. Each heavy chain comprises a heavy chain variable region (abbreviated herein as HCVR or VH) and a heavy chain constant region. The heavy chain constant region comprises three domains, CH1, CH2 and CH3. Each light chain comprises a light chain variable region (abbreviated herein as LCVR or VL) and a light chain constant region. The light chain constant region comprises one domain, CL. The VH and VL regions can be further subdivided into regions of hypervariability, termed complementarity determining regions (CDR), interspersed with regions that are more conserved, termed framework regions (FR). Each VH and VL is composed of three CDRs and four FRs, arranged from amino-terminus to carboxy-terminus in the following order: FR1, CDR1, FR2, CDR2, FR3, CDR3, FR4 (heavy chain CDRs may be abbreviated as HCDR1, HCDR2 and HCDR3; light chain CDRs may be abbreviated as LCDR1, LCDR2 and LCDR3.

A class of immunoglobulins called Immunoglobulin G (IgG), for example, is common in human serum and comprises four polypeptide chains-two light chains and two heavy chains. Each light chain is linked to one heavy chain via a cystine disulfide bond, and the two heavy chains are bound to each other via two cystine disulfide bonds. Other classes of human immunoglobulins include IgA, IgM, IgD, and IgE. In the case of IgG, four subclasses exist: IgG 1, IgG 2, IgG 3, and IgG 4. Each subclass differs in their constant regions, and as a result, may have different effector functions. In some examples described herein, a biopharmaceutical product may comprise a target polypeptide including IgG. In at least one example, the target polypeptide comprises IgG 4.

The term “antibody,” as used herein, also includes antigen-binding fragments of full antibody molecules. The terms “antigen-binding portion” of an antibody, “antigen-binding fragment” of an antibody, and the like, as used herein, include any naturally occurring, enzymatically obtainable, synthetic, or genetically engineered polypeptide or glycoprotein that specifically binds an antigen to form a complex. Antigen-binding fragments of an antibody may be derived, e.g., from full antibody molecules using any suitable standard techniques such as proteolytic digestion or recombinant genetic engineering techniques involving the manipulation and expression of DNA encoding antibody variable and optionally constant domains. Such DNA is known and/or is readily available from, e.g., commercial sources, DNA libraries (including, e.g., phage-antibody libraries), or can be synthesized. The DNA may be sequenced and manipulated chemically or by using molecular biology techniques, for example, to arrange one or more variable and/or constant domains into a suitable configuration, or to introduce codons, create cysteine residues, modify, add or delete amino acids, etc.

Biopharmaceutical products (e.g., target molecules, polypeptides, antibodies) may be produced using recombinant cell-based production systems, such as the insect bacculovirus system, yeast systems (e.g., Pichia sp.), or mammalian systems (e.g., CHO cells and CHO derivatives like CHO-K1 cells). The term “cell” includes any cell that is suitable for expressing a recombinant nucleic acid sequence. Cells include those of prokaryotes and eukaryotes (single-cell or multiple-cell), bacterial cells (e.g., strains of E. coli, Bacillus spp., Streptomyces spp., etc.), mycobacteria cells, fungal cells, yeast cells (e.g., S. cerevisiae, S. pombe, P. pastoris, P. methanolica, etc.), plant cells, insect cells (e.g., SF-9, SF-21, bacculovirus-infected insect cells, Trichoplusiani, etc.), non-human animal cells, human cells, or cell fusions such as, for example, hybridomas or quadromas. According to some aspects of the present disclosure, a cell may be a human, monkey, ape, hamster, rat, or mouse cell. According to some aspects of the present disclosure, a cell may be eukaryotic and may be selected from the following cells: CHO (e.g., CHO K1, DXB-11 CHO, Veggie-CHO), COS (e.g., COS-7), retinal cell, Vero, CV1, kidney (e.g., HEK293, 293 EBNA, MSR 293, MDCK, HaK, BHK), HeLa, HepG2, WI38, MRC 5, Colo205, HB 8065, HL-60, (e.g., BHK21), Jurkat, Daudi, A431 (epidermal), CV-1, U937, 3T3, L cell, C127 cell, SP2/0, NS-0, MMT 060562, Sertoli cell, BRL 3A cell, HT1080 cell, myeloma cell, tumor cell, and a cell line derived from an aforementioned cell. In some examples, a cell may comprise one or more viral genes, e.g. a retinal cell that expresses a viral gene (e.g., a PER.C6™ cell).

The term “target molecule” may be used herein to refer to target polypeptides (e.g., antibodies, antibody fragments, or other proteins or protein fragments), or to other molecules intended to be produced, isolated, purified, and/or included in drug products (e.g., adeno-associated viruses (AA Vs) or other molecules for therapeutic use). While methods according to the present disclosure may refer to target polypeptides, they may be as applicable to other target molecules. AAVs, for example, may be prepared according to suitable methods (e.g., depth filtration, affinity chromatography, and the like), and mixtures including AAVs may be subjected to methods according to the present disclosure. Before or after following one or more methods of the present disclosure, mixtures including AAVs may be subjected to additional procedures (e.g., to the removal of “empty cassettes” or AAVs that do not contain a target sequence).

According to some aspects of the present disclosure, the target molecule is an antibody, a human antibody, a humanized antibody, a chimeric antibody, a monoclonal antibody, a multispecific antibody, a bispecific antibody, an antigen binding antibody fragment, a single chain antibody, a diabody, triabody or tetrabody, a Fab fragment or a F(ab′)2 fragment, an IgD antibody, an IgE antibody, an IgM antibody, an IgG antibody, an IgG1 antibody, an IgG2 antibody, an IgG3 antibody, or an IgG4 antibody. In one example, the antibody is an IgG1 antibody. In one example, the antibody is an IgG2 antibody. In one example, the antibody is an IgG4 antibody. In one example, the antibody is a chimeric IgG2/IgG4 antibody. In one example, the antibody is a chimeric IgG2/IgG1 antibody. In one example, the antibody is a chimeric IgG2/IgG1/IgG4 antibody.

In some aspects, a target molecule (e.g., an antibody) is selected from a group consisting of an anti-Programmed Cell Death 1 antibody (e.g., an anti-PD1 antibody as described in U.S. Pat. Appln. Pub. No. US2015/0203579A1), an anti-Programmed Cell Death Ligand-1 (e.g., an anti-PD-L1 antibody as described in U.S. Pat. Appln. Pub. No. US2015/0203580A1), an anti-Dl14 antibody, an anti-Angiopoetin-2 antibody (e.g., an anti-ANG2 antibody as described in U.S. Pat. No. 9,402,898), an anti-Angiopoetin-Like 3 antibody (e.g., an anti-AngPtl3 antibody as described in U.S. Pat. No. 9,018,356), an anti-platelet derived growth factor receptor antibody (e.g., an anti-PDGFR antibody as described in U.S. Pat. No. 9,265,827), an anti-Prolactin Receptor antibody (e.g., anti-PRLR antibody as described in U.S. Pat. No. 9,302,015), an anti-Complement 5 antibody (e.g., an anti-C5 antibody as described in U.S. Pat. Appln. Pub. No US2015/0313194A1), an anti-TNF antibody, an anti-epidermal growth factor receptor antibody (e.g., an anti-EGFR antibody as described in U.S. Pat. No. 9,132,192 or an anti-EGFRvIII antibody as described in U.S. Pat. Appln. Pub. No. US2015/0259423A1), an anti-Proprotein Convertase Subtilisin Kexin-9 antibody (e.g., an anti-PCSK9 antibody as described in U.S. Pat. No. 8,062,640 or U.S. Pat. Appln. Pub. No. US2014/0044730A1), an anti-Growth And Differentiation Factor-8 antibody (e.g., an anti-GDF8 antibody, also known as anti-myostatin antibody, as described in U.S. Pat. No. 8,871,209 or U.S. Pat. No. 9,260,515), an anti-Glucagon Receptor (e.g., anti-GCGR antibody as described in U.S. Pat. Appln. Pub. Nos. US2015/0337045A1 or US2016/0075778A1), an anti-VEGF antibody, an anti-IL1R antibody, an interleukin 4 receptor antibody (e.g., an anti-IL4R antibody as described in U.S. Pat. Appln. Pub. No. US2014/0271681A1 or U.S. Pat. No. 8,735,095 or U.S. Pat. No. 8,945,559), an anti-interleukin 6 receptor antibody (e.g., an anti-IL6R antibody as described in U.S. Pat. Nos. 7,582,298, 8,043,617 or U.S. Pat. No. 9,173,880), an anti-interleukin 33 (e.g., anti-IL33 antibody as described in U.S. Pat. Appln. Pub. Nos. US2014/0271658A1 or US2014/0271642A1), an anti-Respiratory syncytial virus antibody (e.g., anti-RSV antibody as described in U.S. Pat. Appln. Pub. No. US2014/0271653A1), an anti-Cluster of differentiation 3 (e.g., an anti-CD3 antibody, as described in U.S. Pat. Appln. Pub. Nos. US2014/0088295A1 and US20150266966A1, and in U.S. Application No. 62/222,605), an anti-Cluster of differentiation 20 (e.g., an anti-CD20 antibody as described in U.S. Pat. Appln. Pub. Nos. US2014/0088295A1 and US20150266966A1, and in U.S. Pat. No. 7,879,984), an anti-Cluster of Differentiation-48 (e.g., anti-CD48 antibody as described in U.S. Pat. No. 9,228,014), an anti-Fel d1 antibody (e.g., as described in U.S. Pat. No. 9,079,948), an anti-Middle East Respiratory Syndrome virus (e.g., an anti-MERS antibody), an anti-Ebola virus antibody (e.g., Regeneron's REGN-EB3), an anti-CD19 antibody, an anti-CD28 antibody, an anti-IL1 antibody, an anti-IL2 antibody, an anti-IL3 antibody, an anti-IL4 antibody, an anti-IL5 antibody, an anti-IL6 antibody, an anti-IL7 antibody, an anti-Erb3 antibody, an anti-Zika virus antibody, an anti-Lymphocyte Activation Gene 3 (e.g., anti-LAG3 antibody or anti-CD223 antibody) and an anti-Activin A antibody. Each U.S. patent and U.S. patent publication mentioned in this paragraph is incorporated by reference in its entirety.

According to some aspects of the present disclosure, a target molecule (e.g., a bispecific antibody) is selected from the group consisting of an anti-CD3 x anti-CD20 bispecific antibody, an anti-CD3 x anti-Mucin 16 bispecific antibody, and an anti-CD3 x anti-Prostate-specific membrane antigen bispecific antibody. According to some aspects of the present disclosure, the target molecule is selected from the group consisting of alirocumab, sarilumab, fasinumab, nesvacumab, dupilumab, trevogrumab, evinacumab, and rinucumab.

In some examples, the target molecule is a recombinant protein that contains an Fc moiety and another domain, (e.g., an Fc-fusion protein). In some examples, an Fc-fusion protein is a receptor Fc-fusion protein, which contains one or more extracellular domain(s) of a receptor coupled to an Fc moiety. In some examples, the Fc moiety comprises a hinge region followed by a CH2 and CH3 domain of an IgG. In some examples, the receptor Fc-fusion protein contains two or more distinct receptor chains that bind to either a single ligand or multiple ligands. For example, an Fc-fusion protein is a TRAP protein, such as for example an IL-1 trap (e.g., rilonacept, which contains the IL-1RAcP ligand binding region fused to the Il-1R1 extracellular region fused to Fc of hIgG1; see U.S. Pat. No. 6,927,004, which is incorporated by reference in its entirety), or a VEGF trap (e.g., aflibercept or ziv-aflibercept, which contains the Ig domain 2 of the VEGF receptor Flt1 fused to the Ig domain 3 of the VEGF receptor Flk1 fused to Fc of hIgG1; see U.S. Pat. Nos. 7,087,411 and 7,279,159, both of which are incorporated by reference in their entireties). In other examples, an Fc-fusion protein is a ScFv-Fc-fusion protein, which contains one or more of one or more antigen-binding domain(s), such as a variable heavy chain fragment and a variable light chain fragment, of an antibody coupled to an Fc moiety.

The term “chromatography,” as used herein, refers to any process which separates components of a mobile phase (e.g., a mixture or solution containing multiple constituents) by passing the mobile phase through a medium such that the constituents of the mobile phase pass through the medium at different rates, including, but not limited to, column chromatography, planar chromatography, thin layer chromatography, displacement chromatography, gas chromatography, affinity chromatography (e.g., Protein A or Protein L), ion-exchange chromatography, size-exclusion chromatography, reverse phase chromatography, hydrophobic interaction chromatography (HIC), fast protein liquid chromatography, high-performance liquid chromatography, countercurrent chromatography, periodic counter-current chromatography, chiral chromatography, or mixed-mode chromatography. While examples herein may be disclosed with respect to an exemplary type of chromatography process or apparatus, for example, column chromatography, examples disclosed herein may be applicable to any type of chromatography.

The systems and methods of the present disclosure are directed towards studying chromatographic column performance (e.g., column integrity). Chromatographic columns that are compatible with the methods and systems herein include any column suitable for separating and/or purifying components of a mobile phase and generally configured as described herein.

A chromatographic column (referred to hereafter as “chromatographic column” or “column”) may comprise chromatography media. For example, chromatographic columns may include amino acid media, ligand-specific media, immunoaffinity media, ion affinity media, hydrophobic interaction media, and/or charged media. The media can be in the form of resin, beads, particles bound in a packed bed column format, a membrane, or in any format that can accommodate a mixture or other liquid comprising biopharmaceutical products. The media may include a support structure such as, for example, agarose beads (e.g., sepharose), silica beads, cellulosic membranes, cellulosic beads, hydrophilic polymer beads, or other compactable synthetic structure.

Chromatography media may include one or more ligands configured to interact with one or more components of a mobile phase, and a support structure supporting the one or more ligands. For example, chromatography media may include ligands including a quaternary amine, a Protein A-derived group, a Protein L-derived group, a phenyl group, a sulphopropyl group, a triazabicyclodecene (TBD) group, a trimethylammoniumethyl (TMAE) group, a dimethylaminoethyl (DMAE) group, a sulfoethyl group, or a combination thereof. The support structure may comprise cross-linked agarose, highly-linked agarose, silica, aluminum oxide, methacrylate, glass, polyvinyl ether, or a combination thereof.

Exemplary aspects of systems and methods described herein may be implemented by various types of chromatography systems. Such exemplary chromatography systems may include: mobile phase liquid supply systems; material injection systems; one or more chromatographic columns, as described herein; and components configured to control, determine, and monitor operations of the chromatography system. These components may include process controllers, computing devices, and detectors (e.g., operational parameter-related sensors).

In some examples, chromatographic columns used in the manufacture of biopharmaceutical products may be configured for use in chromatography systems that incorporate automated liquid handling devices. Such devices may include robotic arms or other components configured to hold and move groups of chromatographic columns between different locations within a chromatography system. In some examples, an automated liquid handling device may include a robotic dispensing device configured to hold, move, and actuate a fluid or material dispensing instrument, such as one or more pipettes, over groups of chromatographic columns positioned relative to the fluid or material dispensing instrument. Chromatographic columns configured for use with various exemplary automated liquid handling devices may be configured with media having a bed height of about 25 millimeters (mm) to about 30 mm. In some examples, a chromatographic column may be configured with an inner diameter of about 5 mm to about 10 mm. In addition, according to some aspects of the present disclosure, a chromatographic column may have a total volume (e.g., a column volume) of about 50 microliters (μL) to about 600 μL. In addition or alternatively, a chromatographic column for an exemplary chromatography system may be one in a group of 8, 96, 256, 324, 384, or another number of columns, each column having a column volume in the range of 50 μL to about 600 μL.

Exemplary chromatography systems configured to implement the systems and methods described herein may include any hardware and/or software required to run a chromatographic column, and be configured to: perform any one of various types of chromatography, such as high performance liquid chromatography (HPLC), ion exchange chromatography, size exclusion chromatography, hydrophobic interaction chromatography (HIC), reverse phase chromatography, mixed-mode chromatography, or affinity chromatography; separate biopharmaceutical products in a raw mixture; isolate and/or purify a single type of biopharmaceutical product; and/or eliminate contaminants from a mixture. In some instances, chromatography systems that be utilized for the methods and processes described herein may be a part of a drug product manufacturing system, such as a system for manufacturing a drug product containing a biopharmaceutical product, such as an antibody.

An exemplary mobile phase liquid supply system that may be incorporated in an exemplary chromatography system configured to implement systems and methods described herein, may include and suitable system for supplying a mobile phase to an inlet of a column as described herein. Such a mobile phase liquid supply system may include: one or more reservoirs to hold a mobile phase liquid(s) used to drive raw materials injected through a column; one or more pumps configured to impart pressure to the mobile phase liquid(s); pumps configured to mix two or more solvents (e.g., from two or more reservoirs) in a desired ratio prior to supplying the combined solution to the inlet of a column; and an automated fluid handling device. In addition, an exemplary mobile phase liquid supply system may be configured to supply a first mobile phase to an inlet of a column and then supply a second mobile phase to the inlet after a desired volume of the first mobile phase has been supplied.

An exemplary material injection system that may be incorporated in an exemplary chromatography system configured to implement systems and methods described herein, may be any suitable system for supplying raw material requiring separation and/or purification in a column as described herein. According to some aspects of the present disclosure, for example, an exemplary material injection system may include one or more fluid dispensing instruments in fluid communication with one or more reservoirs to hold raw materials. Such raw materials may include one or more biopharmaceutical products, reagents, solvents, or other materials.

An exemplary process controller and/or computing device that may be incorporated in an exemplary chromatography system configured to implement systems and methods described herein, may be suitable for controlling aspects of the chromatography system during a chromatography run. Such a process controller may be linked and/or configured to operate and/or control one or more parts of a chromatography system according to a desired procedure. Such parts may include a mobile phase liquid supply system, a material injection system, a column, a computing device, and a detector. According to a desired procedure. For example, in some examples, a process controller may be programmed to switch pumps of a mobile phase liquid supply system on and off, turn a detector on and off, or the like. In addition, an exemplary process controller may have a display and/or other user interface elements (e.g., buttons, a mouse, a keyboard, a touch screen, etc.), through which commands may be input by, e.g., a human operator.

One or more computing devices may be incorporated in an exemplary chromatography system configured to implement systems and methods described herein, may be any computing device, such as a desktop computer, a server computer, a laptop, a tablet, or a personal portable device (e.g., a smart phone). Such computing devices may have displays and/or other user interface elements (e.g., buttons, a mouse, a keyboard, a touch screen, etc.) through which commands may be input by, e.g., operators. As described herein, computing devices may collect data from process controllers and/or other parts of an exemplary chromatography systems (e.g., a detector). According to some aspects of the present disclosure, computing devices include one or more programs configured to display or output data, e.g., to a screen, a hard disk, or via an internet connection to a remote location. Computing devices may be connected to other aspects of a chromatography system via a wired connection. In addition or alternatively, computing systems may be connected to other aspects of a chromatography system via a wireless connection. For example, a process controller may be located remotely in relation to an exemplary chromatography system, and be configured to display data regarding one or more chromatography operations via a user interface and/or control aspects of the chromatography operations.

Detectors that may be included within the chromatography systems described herein may include any type of detector suitable for detecting one or more characteristics at an inlet, body, or outlet of a column as described herein. Such characteristics may include, for example, conductivity, pH, optical density, and/or absorbance (e.g., ultraviolet and/or visible light). According to some aspects of the present disclosure, an exemplary detector may include an electrical conductivity detector, an ultraviolet (UV) detector, a fluorescence detector, a refractive detector, a pH detector, and/or a pressure gauge. For example, an exemplary detector may measure an absorbance of UV light (e.g., a wavelength of 280 nm, 275 nm, etc.), and the measured absorbance may correlate to a concentration of a component of a mobile phase.

Chromatography operations may include a sequence of one or more steps, including, for example, one or more pre-equilibration steps, equilibration steps, loading steps, wash steps, elution steps, strip steps, and/or regeneration steps. One or more steps of a chromatography operation may be tracked and/or recorded using data collected from a detector at the outlet of a chromatographic column. For example, the signal received by the detector may be plotted as a function of volume passed through the detector. In some examples, the signal received by the detector may be plotted as a function of time elapsed. Data collected from the detector, including plots generated from signals received by the detector, may be used to monitor, track, and/or validate a chromatography operation. For chromatography operations involved in the manufacture of biopharmaceutical products, monitoring the quality, consistency, and integrity of chromatography operations is required to ensure that the manufactured biopharmaceutical product meets internal quality assurance metrics, and specifications of applicable regulatory bodies.

As a chromatography operation transitions from a first step to a second step, the composition of the mobile phase eluting from the column (e.g., passing by the detector) may change. Depending on the type of signal and the steps of the transition, a transition may be detected as an increase (a step-up transition) or decrease (step-down transition) in a signal received by the detector, followed by a plateau of that signal after transition has occurred.

Column integrity refers to the ability of chromatographic column to perform at maximum efficiency. Variations in axial dispersion of chromatography media within a chromatographic column may affect the ability of the chromatographic column to perform at maximum efficiency. In addition or alternatively, variations in radial dispersion of chromatography media within the chromatographic column may affect the ability of the chromatographic column to perform at maximum efficiency. Depending on the type of chromatographic column (e.g., type of chromatography media in the column), diminishment of column integrity may cause a lack of binding of components of the mobile phase to the column, a lack of separation between components of the mobile phase, and/or introduction of impurities into the mobile phase. When a chromatographic column is not operating at maximum efficiency, the column integrity of the chromatographic column is diminished.

The column integrity of chromatographic column may be determined by the characteristics of how a mobile phase flows through a stationary phase (e.g., chromatography media) of the column. Signals detected from the detector may be plotted against time elapsed, and/or volume passed of the chromatography operation. These plots are referred to as chromatograms, and can be used to monitor the progress of a chromatography operation, and determine whether the chromatography operation is proceeding within acceptable operating parameters. For example, the presence of abnormal characteristics in a chromatogram may be indicative of diminished column integrity.

The extent to which the column integrity of a chromatographic column is diminished may be quantified by determining the height equivalent of a theoretical plate (HETP) or number of theoretical plates of the chromatographic column. Compared to a column operating at maximum efficiency, chromatographic columns with diminished column integrity may have an increased HETP and/or a decreased number of theoretical plates. Other methods of quantifying column integrity include transition analysis, where peaks of a chromatogram are analyzed relative to historical or expected chromatogram peaks. Variation in the peaks of a chromatogram identified in transition analysis may indicate that the chromatographic column used to generate the chromatogram has diminished column integrity.

Diminished column integrity can result from disruptions in the chromatography media within the column, and these disruptions may negatively affect the ability of material to flow through the column. The disruptions that can cause diminished column integrity may be the result of repeated use of the chromatographic column. Disruptions in the chromatography media may cause material to flow through the column too quickly without contacting a sufficient quantity of chromatography media to effectively separate components of the introduced material. Additionally or alternatively, disruptions may block the flow of material through regions of the column, which can also lead to reduced efficiency of the column.

One type disruption within chromatography media, channeling, refers to the presence of voids within the chromatography media that may cause the mobile phase to advance through the chromatography media more rapidly than the average flow velocity of the chromatography operation. Chromatography media that becomes too dense may crack, which can lead to channeling and the formation of voids within chromatography media. Channeling can cause a lack of separation of components of the mobile phase, as the preferential flow of the mobile phase through voids of the chromatography media reduces the interaction between components of the mobile phase and the chromatography media.

Another type of disruption within chromatography media, fouling, refers to pores or flowpaths of the chromatography media being blocked. For example, support structures of the chromatography media may become embedded in a filter screen within the chromatographic column. The embedded media can prevent a mobile phase from flowing through portions of the chromatographic column. Poor flow caused by blockages may lead to the formation of a biofilm or other growth that further disrupts movement of a mobile phase through the chromatographic column. Fouling may cause a first portion of a mobile phase to flow slower than a second portion of the mobile phase. The resulting lag of elution of the mobile phase through the column can result in poor separation of mobile phase components. The lag of elution may also cause peak broadening and peak tailing. Therefore, detection of peak broadening, peak tailing, and/or poor resolution of peaks, can be indicative of fouling.

Diminished column integrity may also be detected by the presence of asymmetrical chromatogram peaks. For example, a chromatogram plotted based on a chromatography operation utilizing a column that has diminished column integrity, can include fronted and/or tailed peaks. Peak fronting refers to an asymmetrical peak, where the front half of a chromatography peak is broader than the back half of the chromatography peak. Peak tailing refers to an asymmetrical peak, wherein the back half of the chromatography peak is broader than the front half of the chromatography peak.

Methods and systems for assessing chromatographic column integrity described herein are applicable to a wide range of types and sizes of chromatography systems. More specifically, methods and systems of the present disclosure may be implemented to assess the integrity of chromatographic columns having volumes in the range of about 50 μL to about 600 μL (e.g., robocolumns). For example, methods and systems of the present disclosure may be implemented to assess the integrity of chromatographic columns (e.g., pre-packed columns) configured for use with robotic fluid handling systems and/or automated fluid handling workstations.

Methods and systems for assessing chromatographic column integrity described herein are applicable to membrane chromatography systems. One of ordinary skill in the art will recognize that generally, membrane chromatography involves the use of a micro porous membrane with ion exchange groups in the membrane pores to capture target molecules by absorption. Accordingly, methods and systems of the present disclosure may be implemented to assess the integrity of chromatographic columns that are not required to be pre-packed, but rather incorporate media in the form of a membrane and/or media that includes a support structure utilizing membranes (e.g., cellulosic). Such chromatographic columns may be configured for use with robotic fluid handling systems and/or automated fluid handling workstations. A membrane thickness may therefore define a loading parameter, or more generally, an aspect of a chromatography protocol, capable of being adjusted, varied, and controlled. At the same time, an effect of changes to a membrane thickness on performance criteria may be monitored and/or recorded.

According to some aspects of the present disclosure, methods for assessing chromatographic column integrity may include assessing the integrity of columns within a chromatography system including an automated fluid handling device. Chromatography systems of the present disclosure may include multiple (e.g., 8, 64, 96, 256, 324, 384, etc.) chromatographic columns in an array (e.g., a grid of rows and columns) and configured to be used with liquid handling workstations, such as robotic liquid handling workstations.

Automated fluid handling devices may include robotic arms or other types of computing device-controlled components configured to handle, move, reposition, or otherwise operate chromatographic columns. Automated fluid handling devices may include robotic arms or other types of computing device-controlled components (e.g., micropipettes) configured to dispense materials (e.g., a load and/or a mobile phase) into the chromatographic columns. Automated fluid handling devices may be capable of directing an eluate from one or more chromatographic columns to an outlet (e.g., a well plate) or one or more other components (e.g., columns) of the automated fluid handling device.

In a chromatography system including multiple chromatographic columns, an automated fluid handling device may perform operations on each column simultaneously, sequentially, randomly, and/or in an order that is algorithmically determined. Automated fluid handling devices as described herein may be operated and controlled by one or more computing devices. Such computing devices may be embodied by a centralized device having one or more processors, a memory, storage, and instructions that (a) are stored in or otherwise accessible from the memory and/or storage, and (b) may be read and executed by the one more processors to perform the operations mentioned above with respect to one or more chromatographic columns and/or one or more groups of multiple chromatographic columns. In other examples, a computing device may be a distributed computing device and/or network of devices.

Computing devices described herein may be configured to direct and monitor the operations of automated fluid handling devices performing operations that are associated with or part of chromatography runs involving groups of multiple chromatographic columns arranged on trays, decks, or plates with each column having the same volume in a range of have volumes in the range of 50 μL to about 600 μL.

As described above, methods and systems of the present disclosure may be implemented to assess the integrity of chromatographic columns having volumes in the range of about 50 μL to about 600 μL (e.g., robocolumns). Relative to chromatographic columns of greater volumes (e.g., 0.1 L to 277 L), use of multiple chromatographic columns, each having a volume in the range of about 50 μL to about 600 μL, may save time and improve work flexibility. Furthermore, smaller amounts of materials may be required. According to some aspects of the present disclosure, use of multiple chromatographic columns, each having a volume in the range of about 50 μL to about 600 μL, may require, for example, approximately 5% of buffer or other materials, compared to conventionally-sized chromatography operations. Other advantages may include chromatography investigations that are faster and more comprehensive owing to the increasing parallel processing (e.g., parallel purification) throughput characteristic of these types of multi-chromatographic column investigations.

Even with the advantages mentioned above, diminished column integrity in chromatographic columns having volumes in the range of about 50 μL to about 600 μL may still result in a loss of product having substantial cost. The dimensions of these types of chromatographic columns may inhibit the detection of data used to assess column integrity. For example, the dimensions of the columns and low operating volumes associated with the columns may not allow for a sufficient number of readings to be made in order to generate transition plot data for transition analysis. Additionally, due to the size constraints of these columns, inline conductivity data may not be obtainable for monitoring and/or determining chromatographic column integrity. Accordingly, conventional methods are not available for assessing column integrity in order to determine if the columns may be re-used.

Furthermore, the large numbers (e.g., 96, 256, 324, 384) of these types of chromatographic columns used for single chromatography runs are not conducive to reliably tracking of assessed column integrity over multiple uses. As a result of these challenges, these types of chromatographic columns, having volumes in the range of about 50 μL to about 600 μL, are often rendered to be single use (single chromatography run) columns.

Systems and methods of the present disclosure relate to chromatography operations (e.g., pre-use assessments) that allow for the assessment of column integrity for chromatographic columns having a column volume of about 50 μL to about 600 μL (e.g., robocolumns). Additionally, methods and systems of the present disclosure may use column integrity as a factor in assessing whether a chromatographic column is suitable for use (e.g., re-use). Further, methods and systems of the present disclosure may be used to develop pre-use assessments. Systems and methods of the present disclosure may additionally include tracking column integrity, testing conditions, and use or re-use indication determinations for a chromatographic column.

In some examples, a pre-use assessment may include introducing a tracer agent into the column. Suitable tracer agents includes those where a concentration of the tracer agent correlates to an absorbance of the solution. For example, the absorbance measured by a detector at the outlet of a chromatographic column may correspond to a concentration of the tracer agent within the mobile phase. The tracer agent may be a UV tracer that does not interact with chromatographic resins. In some examples, the tracer agent may be acetone or tryptophan. A volume of the tracer agent and/or concentration of tracer agent used in the pre-use assessment may be adjusted based on a size, a mode, and/or a use history of a chromatographic column being evaluated. As described herein, absorbance (e.g., UV absorbance) measured during a pre-use assessment may be used to generate values of one or more performance parameters that relate to column integrity. Methods and systems of the present disclosure may include using regression algorithm to fit a function to absorbance measurements, and using the function to generate additional data points for use in a transition analysis.

In some examples, a column may be washed prior to performing the pre-use assessment, for example, to remove a storage buffer from the column. The transition from the washing buffer (e.g., water) to the tracer agent (e.g., acetone) in a pre-use assessment may generate a step-up transition on a chromatogram generated from absorbance measurements of the transition. FIG. 1 depicts an exemplary normalized plot of a chromatography step-up transition, divided into three phases. Prior to the transition, a detector detects a baseline value of a signal (e.g., a conductivity, an absorbance, and/or a pH). During transition, the signal “steps up” or increases, and then plateaus after transition. In some cases, the plateau after a step-up transition is due to detector saturation. The data derived during transition are quantitative and sensitive to subtle changes in performance of the column. Examples of measurable parameters (e.g., signals) that may change over a transition include conductivity, pH, absorbance, and fluorescence. One of ordinary skill in the art will understand, however, that any other measurable parameters that may change over a transition may be of use in transition analyses according to the present disclosure.

FIG. 2 depicts an exemplary measuring process 200 for obtaining measurements for a pre-use assessment, according to aspects of the present disclosure. FIG. 4, on the other hand, depicts an exemplary assessment process 400 for facilitating evaluations of chromatographic column integrity, according to some aspects of the present disclosure. The descriptions of FIGS. 2 and 4 refer to applications of the measuring and assessment processes 200, 400 with respect to a single chromatographic column. However, measuring process 200, assessment process 400, and any other process, sub-process, method, step, or system application described herein may be implemented with a plurality of chromatographic columns (e.g., simultaneously or in a predetermined order). For example, measuring process 200 may be performed on multiple columns simultaneously utilizing an automated fluid handling device. Thus, an application of any portion of the measuring process 200 (or the assessment process 400) described with respect to one chromatographic column, is equally applicable to a group chromatographic columns. Groups of chromatographic columns may be arranged in rows of chromatographic columns, with each row have the same number of columns, and each column having the same column volume and bed height. In one particular example, several rows of 8 chromatographic columns may be run in parallel, and each chromatographic column may have a volume of 600 μl and bed height of 3 cm.

Further, those of ordinary skill will understand that the steps of measuring process 200 and assessment process 400 are exemplary. Other combinations and/or permutations of the components of the systems and methods described herein may be used to obtain measurements from a chromatography operation including a chromatographic column, and assess the column integrity of the column.

Referring to FIG. 2, measuring process 200 may include washing a chromatographic column (step 210). For example, washing the column may include removing a storage buffer from the column. Washing the column may include passing about 1 column volume to about 5 column volumes, such as, for example, about 2.5 column volumes to about 4.5 column volumes, or about 3 column volumes to about 4 column volumes, of a washing buffer through the chromatographic column. Suitable washing buffer may be compatible with chromatographic resins and exhibit low levels of UV absorbance. For example, the washing buffer may include water (e.g., reverse osmosis deionized water). The storage buffer may include water, an alcohol (e.g., ethanol), and/or one or more salts. In some aspects, such as, for example, those involving ion exchange chromatography (e.g., anion exchange chromatography or cation exchange chromatography), the storage buffer may comprise ethanol (e.g., approximately 20 percent by volume (vol. %) ethanol), and approximately 150 mM of sodium chloride. In other aspects, for example, those involving hydrophobic interaction chromatography, size exclusion chromatography, affinity chromatography, and/or mixed-mode chromatography, the storage buffer may comprise ethanol (e.g., approximately 20 vol. % ethanol). In one or more examples, after performing a pre-use assessment on a chromatographic column, one or more column volumes (e.g., two column volumes) of storage buffer may be introduced into the column, and a portion of the storage buffer may remain in the column.

Measuring process 200 may include introducing n column volumes (CV) of a fluid composed of z % tracer agent at a flow rate y (e.g., a flow rate in terms of microliters per second) (step 220). Values for n, z, and y may depend on the tracer agent chosen, the dimensions of the column being used (e.g., column volume, bed height, inner diameter, or other physical dimension of the column), the composition of chromatography media within the column, and/or operational parameters of an automated fluid handling system being used. As described herein, developing a pre-use assessment protocol may include running chromatography operations with different values of n, z, and y, and experimentally determining values for n, z, and y to be used in the pre-use assessment protocol (e.g., values for n, z, and y used in measuring process 200). In some examples, historical data regarding previously conducted pre-use assessments may be used in determining values of n, z, and y.

In some examples, the value of n may be about 0.5 to about 8, such as, for example, about 1.0 to about 6.0, about 2 to about 5, about 2.5 to about 4.5, about 3, about 3.5, or about 4. The value of z may correspond to a concentration of the tracer agent within the mobile phase used for measuring process 200, in terms of volume percentage (vol. %). In one or more examples, the value of z may be about 0.1 to about 10, such as, for example, about 0.5 to about 7.5, about 1 to about 5, about 1, about 2, about 3, about 4, or about 5. Flow rate y may be expressed in terms of microliters per second (μL/s). In some examples, the value of y may be about 0.1 μL/s to about 5 μL/s, such as, for example, about 0.1 μL/s to about 4 μL/s, about 0.3 μL/s to about 5 μL/s, about 0.3 μL/s to about 4 μL/s, about 0.5 μL/s to about 4 μL/s, about 0.5 μL/s to about 3 μL/s, about 0.6 μL/s to about 4 μL/s, or about 0.6 μL/s to about 3 μL/s.

Still referring to FIG. 2, measuring process 200 may include collecting b fractions of an eluate (step 230). For example, after the tracer agent is introduced, several fractions of an eluate may be collected. The fractions may be evenly collected such that the volume of each fraction is approximately the same. In some examples, the fractions are collected in a well plate, such as, for example, a 12-well plate, 24-well plate, a 96-well plate, a 384-well plate, or another well plate configuration. As described herein, developing a pre-use assessment protocol may include running chromatography operations with different values of b, and experimentally determining the value of b to be used in the pre-use assessment protocol (e.g., value for b used in measuring process 200). In addition or alternatively, historical data regarding previously conducted pre-use assessments may be used in determining the values of b. In some examples, the value of b may be about 6 to about 48, such as, for example, about 8 to about 36, about 12 to about 24, about 12, or about 24.

During or after the collection of b fractions of eluate, the absorbance of each fraction may be measured (step 240). As discussed herein with reference to FIG. 4, the absorbance measurements may provide raw data which forms the basis of assessing the column integrity. In one example, a detector may be operated to obtain the absorbance measurements at (step 240) as part of the measuring process 200. The wavelength of light used for the absorbance measurement may depend on the tracer agent used. In examples where the tracer agent is acetone, the absorbance of light with a wavelength of 275 nanometers may be used. In some examples the measure of absorbance may include a path length corrected absorbance. Path length corrected absorbance may include a measure of absorbance received by a detector, divided by a path length over which the absorbance was measured by the detector. For example, some wells of a plate may contain different depths and/or volumes than other wells of the plate. By measuring a path corrected absorbance, the effect of depth and/or volume of a sample within a well of a plate will not impact data collected by the detector.

As described herein, chromatography operations may be performed with different values of n, z, y, and b to determine optimum values of parameters for a given combination of chromatography system (e.g., including a set of column size parameters and chromatography media composition) and tracer agent. Each chromatogram shown in FIGS. 3A-3D was generated using chromatographic columns including Protein A affinity chromatography media. The chromatographic columns included a column volume of 589 μL and a bed height of 3 centimeters. Each column used to generate the chromatograms shown in FIGS. 3A-3D was stored in a storage buffer comprising 20 vol. % ethanol. Prior to generating the chromatograms shown in FIGS. 3A-3D, approximately 3-4 CVs of water were passed through each column. To generate the chromatograms shown in FIGS. 3A-3D, n CV of a tracer agent solution comprising x vol. % acetone were introduced into the column at a flow rate of y μL/s, and b fractions of the eluate were collected.

FIG. 3A shows the chromatograms of eight chromatography operations run in parallel using a chromatography system including an automated fluid handling device. Each of the eight chromatography operations included passing three column volumes of a solution including 5 vol. % acetone through a chromatographic column at a flow rate of 0.6 μL/s, and collecting twelve fractions of the eluate. The data points in the plot of FIG. 3A show the absorbance measurements for each of the twelve fractions of each of the eight chromatography operations (i.e., for a total of 96 absorbance measurements), and each of the eight chromatography operations is indicated with a different type of data point marker. A regression algorithm was used to generate a line of best fit for each chromatography run, and the lines of best fit are also shown in the plot of FIG. 3A.

FIG. 3B shows the chromatograms of eight chromatography operations run in parallel using a chromatography system including an automated fluid handling device. Each of the eight chromatography operations included passing four column volumes of a solution including 5 vol. % acetone through a chromatographic column at a flow rate of 0.6 μL/s, and collecting 24 fractions of the eluate. The data points in the plot of FIG. 3B show the absorbance measurements for each of the 24 fractions of each of the eight chromatography operations (i.e., for a total of 192 absorbance measurements), and each of the eight chromatography operations is indicated with a different type of data point marker. A regression algorithm was used to generate a line of best fit for each chromatography run, and the lines of best fit are also shown in the plot of FIG. 3B.

FIG. 3C shows the chromatograms of eight chromatography operations run in parallel using a chromatography system including an automated fluid handling device. Each of the eight chromatography operations included passing three column volumes of a solution including 1 vol. % acetone through a chromatographic column at a flow rate of 0.6 μL/s, and collecting 24 fractions of the eluate. The data points in the plot of FIG. 3C show the absorbance measurements for each of the twelve fractions of each of the eight chromatography operations (i.e., for a total of 192 absorbance measurements), and each of the eight chromatography operations is indicated with a different type of data point marker. A regression algorithm was used to generate a line of best fit for each chromatography run, and the lines of best fit are also shown in the plot of FIG. 3C.

FIG. 3D shows the chromatograms of eight chromatography operations run in parallel using a chromatography system including an automated fluid handling device. Each of the eight chromatography operations included passing four column volumes of a solution including 5 vol. % acetone through a chromatographic column at a flow rate of 3 μL/s, and collecting 24 fractions of the eluate. The data points in the plot of FIG. 3D show the absorbance measurements for each of the twelve fractions of each of the eight chromatography operations (i.e., for a total of 192 absorbance measurements), and each of the eight chromatography operations is indicated with a different type of data point marker. A regression algorithm was used to generate a line of best fit for each chromatography run, and the lines of best fit are also shown in the plot of FIG. 3D.

The best fit lines shown in FIG. 3A have an approximately sigmoidal shape. However, the relatively reduced number of fractions collected resulted in a lack of clear plateaus in the baseline and saturation phases. The best fit lines shown in FIG. 3B are linear, and do not resemble the sigmoidal shape associated with a chromatography transition. Without being limited by theory, the linear shape of the best fit lines may be caused by a tracer agent concentration that is too great. The best fit lines shown in FIG. 3C are sigmoidal, and show clear plateaus in the baseline and saturation phases. However, there is a relatively low separation between the baseline and saturation phases. The best fit lines of FIG. 3D are sigmoidal, and show clear and separated plateaus in the baseline and saturation phases. Based on the chromatograms shown in FIGS. 3A-3D, a pre-use assessment protocol was developed that included passing three column volumes of 1 vol. % acetone at a flow rate of 3 μL/s, and collecting 24 fractions of the eluate.

It will be appreciated from a review of the chromatograms of FIGS. 3A-3D that in investigations where a concentration of acetone is below a certain threshold, transition data generated may be insufficient to perform a transition analysis. For example, a slope of the resulting plot may be too steep to perform a transition analysis. In investigations where an insufficient amount (e.g., column volumes) of a tracer agent was used, a full transition will not be recorded. In investigations where an excess amount (e.g., column volumes) of tracer agent was used, the resulting plot may include a long plateau corresponding to indicating a stable state after breakthrough of the tracer agent.

According to some aspects of the present disclosure, a metric related to how well the absorbance measurements or best fit lines are correlated to a transition function may be determined for each chromatogram generated using a different chromatography operation. For example, a co-efficient of determination (R²) may be calculated based on the regression of a best fit line or a transition function for each chromatography operation. The co-efficients of determination may be compared, and parameters (e.g., tracer agent volume, tracer agent concentration, fractions of eluate collected) the chromatography operation that generated the greatest co-efficient of determination may be selected for a pre-use assessment protocol.

As previously described, a pre-use assessment protocol may include assessing a column integrity of the chromatographic column being analyzed and/or generating a performance parameter related to the column integrity. FIG. 4 depicts, in flowchart form, an exemplary assessment process 400 for generating one or more performance parameters related to the column integrity of a chromatographic column. The assessment process 400 may include generating a first data structure based on absorbance measurements (step 410). For example, generating a first data structure may include creating a computer-readable file including absorbance measurements obtained via a measuring process 200 described herein, and time or volume values associated with the absorbance measurements. In some examples, the first data structure may include a two dimensional array of values, such as, for example, a table including rows and columns. The array may be readable by a programming language (e.g., PYTHON, JAVA, JAVASCRIPT, C++). In some examples, the first data structure may include a dataframe or other data structure defined by a programing language (e.g., PYTHON, R, or the like.) Generating the first data structure may include converting absorbance measurements into a format specified by a system, computing device, or other data processing component.

The assessment process 400 may include implementing a fitting algorithm based on the first data structure to generate a transition function (step 420). The transition function may approximate an absorbance of the eluate of a chromatography at a given volume or time of the chromatography operation. According to some aspects of the present disclosure, the fitting algorithm may generate a function that relates the volume passed of a chromatography operation to the absorbance of an eluate of the operation. In some examples, the fitting algorithm generates as output, simulation data that may provide an estimate or a series of estimates for a variable output of a first parameter (e.g., absorbance) relative to known values of a second parameter (e.g., time, volume). In some examples, values for the first and second parameters may correspond to discrete or scale-normalized computations thereof. The fitting algorithm may include one or more logistic functions, cumulative functions, or other types of regressive analyses.

The transition function generated by the fitting algorithm may include one or more sigmoid functions (e.g., a four parameter or five parameter sigmoid function), one or more Gaussian functions (e.g., an exponentially modified Gaussian function), and/or one or more other functions that relate the volume passed or time elapsed of a chromatography operation to the absorbance of an eluate of the operation. For example, a four parameter sigmoid function may be defined according to Equation 1, shown below.

$$\hat{y} = P 1 + \frac{P 2}{1 + {e}^{{P}_{3} ( {x}^{′} - {P}_{4} )}} \qquad Equation ( 1 )$$

Referring to Equation 1, ŷ represents a predicted or fitted value of a response variable y, where y is a path length corrected absorbance and both y and ŷ are measured in Au/cm. The term x′ represents a flushing volume (measured in CV) which corresponds to a volume of a tracer agent solution that is passed through a chromatographic column in implementing a pre-use assessment protocol. P1, P2, P3, and P4 are constants that relate to aspects of a transition function. For example, P1 corresponds to a lower asymptote or minimum value of the response variable that a transition function approaches as x′ approaches negative infinity. P2 corresponds to an upper asymptote or maximum value of the response variable that the transition function approaches as x′ approaches positive infinity. P3 corresponds to a slope parameter that represents the rate at which the response variable of the transition function progresses from the lower asymptote to the upper asymptote. P4 corresponds to an inflection point or midpoint parameter that represents the value of x′ at the point of the transition function with the steepest slope. For example, the midpoint may correspond to a value of the response variable halfway between the lower and upper asymptotes.

Generating a transition function may include defining a four parameter sigmoid function according to Equation 1. Defining the four parameter sigmoid function may include identifying the values of fitting parameters P1, P2, P3, and P4 that best describe the transition of the chromatography operation.

An exponentially modified Gaussian function may be defined according to Equation 2, shown below.

$$Equation ( 2 )$$

$$F ( x ) = \text{} \frac{A}{2} \cdot exp ( - \frac{x}{{t}_{0}} ) ( exp ( \frac{2 m \cdot {t}_{0} + {s}^{2}}{2 {t}_{0}^{2}} ) \cdot ( erf ( \frac{\frac{x - m}{s} - \frac{s}{{t}_{0}}}{\sqrt{2}} ) + \text{} 1 ) ) - exp ( \frac{x}{{t}_{0}} ) \cdot \text{} erf ( \frac{x - m}{\sqrt{2} s} ) + y$$

Referring to Equation 2, F(x) represents a predicted or fitted value of a response variable and corresponds to a path length corrected absorbance (measured in Au/cm). The x term represents a flushing volume (measured in CV) which corresponds to a volume of a tracer agent solution that is passed through a chromatographic column in implementing a pre-use assessment protocol. The A term represents an amplitude (maximum height) of transition function represented by F(x) for a range of x. The to term represents a decay constant (time constant) for rate of a decay of transition function. The m term represents the mean Gaussian distribution, and s represents the standard deviation of the Gaussian distribution. The term erf represents an error function, a standard mathematical function measuring a probability of a normally distributed random variable falling within a certain range of values, for the transition function. In Equation 2, y represents the offset of transition function.

Generating a transition function may include defining an exponentially modified Gaussian function according to Equation 2. The modified Gaussian function of Equation 2 may include a flush volume (CV) as an input and a path length corrected absorbance (Au/cm) as an output.

A five parameter sigmoid function may be defined according to Equation 3, shown below.

$$\hat{y} = P 1 + \frac{P 2}{1 + {f}_{x} \cdot {e}^{{P}_{3} ( {P}_{4} - {x}^{′} )} + ( 1 - {f}_{x} ) \cdot {e}^{{P}_{5} ( {P}_{4} - {x}^{′} )}} \qquad Equation ( 3 )$$

Referring to Equation 3, ŷ represents the response variable and corresponds to a path length corrected absorbance (e.g., measured in Au/cm). The x′ term represents the independent variable and corresponds to a flushing volume (e.g., measured in CV). Generating a transition function may include defining a five parameter sigmoid function according to Equation 3. Defining the five parameter sigmoid function may include identifying the values of constants P1, P2, P3, P4, and P5 that best describe the transition of the chromatography operation. For example, P3 corresponds to an upper asymptote or maximum value of the response variable that the transition function approaches as x′ approaches positive infinity. P4 corresponds to an inflection point or midpoint parameter that represents the value of x′ at the point of the transition function with the steepest slope. For example, the midpoint may correspond to a value of the response variable halfway between the lower and upper asymptotes. P5 corresponds to a lower asymptote or minimum value of the response variable that a transition function approaches as x′ approaches negative infinity.

The scaling factor fₓ (e.g., a factor having a value of 0-1) of Equation 3 operates to determine weight of a first term in the denominator relative to a second term in the denominator. The scaling factor fₓ may be defined according to Equation 4, shown below.

$${f}_{x} = \frac{1}{1 + \cdot {e}^{{\overline{C}}_{f} \cdot ( {P}_{4} - {x}^{′} )}} \qquad Equation ( 4 )$$

The C̅_{f} term is calculated as a reciprocal of a mean of reciprocals according to Equation 5, shown below.

$${\overline{C}}_{f} = \frac{2 \cdot P 3 \cdot P 5}{\vert P 3 + P 5 \vert} \qquad Equation ( 5 )$$

In some examples, the fitting algorithm may be implemented utilizing, for example, an exemplary computing device that performs at least some aspects of step 420 until the simulation data includes a minimum number of data entries. In one example, each data entry may include a volume and corresponding value that represents an absorbance measurement.

Still referring to FIG. 4, assessment process 400 may include generating a second data structure based on the transition function (step 430). Generating the second data structure may include creating a computer-readable file including absorbance values, and time or volume values associated with the absorbance values. The absorbance values may be generated according to the transition function. For example, the second data structure may include a series of time or volume values that are associated with different points of a chromatography operation. The second data structure may also include absorbance values associated with each of the time or volume values, where each absorbance value was calculated using the time or volume value, and according to the transition function. The time or volume values may be predetermined, chosen by an algorithm according to aspects of the transition function and/or chromatography operation, or chosen by a user.

The second data structure may include a two dimensional array of values, such as, for example, a table including rows and columns. The array may be readable by a programming language (e.g., PYTHON, JAVA, JAVASCRIPT, C++). In examples, the second data structure may include a dataframe or other data structure defined by a programing language (e.g., PYTHON, R.).

The first data structure may include combinations of values, wherein each combination of values includes a value of a time or a volume corresponding to a point of a chromatography operation and an absorbance measured at that point of the chromatography operation. As non-limiting examples, the first data structure may include 10, 12, 16, 20, 24, 30, or 40 combinations of values, where each combination of values includes a value that corresponds to a volume and a value that corresponds to an absorbance that was measured at the corresponding volume. The second data structure may also include combinations of values, wherein each combination of values includes a value of a time or a volume corresponding to a point of a chromatography operation and an absorbance measured at that point of the chromatography operation. The second data structure may include more combinations of values than the first data structure. As non-limiting examples, the second data structure may include 50, 100, 150, 200, 250, 300, or 500 combinations of values. According to some aspects of the present disclosure, there may be varying degrees of overlap between the combinations of values in the first and the second data structures. For example, the second data structure may be entirely unique relative to the first data structure such that there is no overlap of values there-between. In other examples, combinations of values within the second data structure may include one or more volume or time values that are the same as volume or time values from the combinations of values within the first data structure.

Still referring to FIG. 4, assessment process 400 may include generating a transition plot based on the first and/or second data structures (step 440). For example, the transition plot may be generated based solely on the second data structure, or on a combination of the first data structure and the second data structure.

The first and second data structure may include a two-dimensional array of values, with a first dimension corresponding to actual or indexed volumes or times for which absorbance measurements were measured, and a second dimension corresponding to measured absorbance values. In some examples, each dimension may or may not include discrete measured or generated values such that one or both dimensions encompass normalized or filtered values derived from or otherwise associated with empirical or indexed values for volume and corresponding empirical or generated values for absorbance. In turn, transition plots according to the present disclosure may be generated by setting an X-axis to correspond to volume or time and Y-axis to correspond to absorbance.

Transition plot-related data (TPRD) may include all the measured and generated data included in the first and second data structures, and/or any raw measurements from which the first data structure may be derived. In addition or alternatively, TPRD may include any data corresponding to characteristics of the chromatographic columns or a pre-use assessment protocol (e.g., values for n, b, z, bed height, column volume) for obtaining measurements. In addition, TPRD may include information regarding the transition function and one or more co-efficients of correlation associated with the transition function.

Assessment process 400 may include generating a value for a performance parameter, based on the TRPD (step 450). For example, a transition analysis may be performed based on the TRPD to generate values for one or more performance parameters. Exemplary performance parameters include, but are not limited to, a non-Gaussian height equivalent of a theoretical plate (NG-HETP), a number of theoretical plates, a skew, a statistical measure of how well regression predictions approximate real data points (e.g., a coefficient of determination (also referred to as R²)), Gaussian height equivalent of a theoretical plate (G-HETP), or a combination thereof. Additional examples of transition analyses, and using transition analyses to generate performance parameter values, are described in U.S. Pat. No. 11,333,642, which is incorporated by reference in its entirety.

The generated performance parameters may be used to assess the column integrity of the chromatographic column used in the pre-use assessment (e.g., a pre-use assessment including a measuring process 200 and an assessment process 400). For example, an increase in NG-HETP or decrease in the number of theoretical plates may indicate a loss of column integrity. In particular, a disruption in a column that decreases a packing efficiency of a column my result in an increase in NG-HETP. Such a disruption may involve, for example, channeling within the chromatographic media. Similarly, an increased skew may indicate a loss of column integrity. For example, a disruption in axial or longitudinal dispersion of chromatography media (e.g., uneven packing of the column) may result in a skew that deviates from the mean.

In some examples, performance parameters (e.g., NG-HETP and skew) may be observed in pre-use chromatography runs and compared to one or more previous pre-use chromatography runs as part of a trend analysis for one or more columns. In some examples, a value of a performance parameters that is a threshold number of standard deviations from an average, expected, or prior value of the performance parameter may indicate that column evaluation, column remediation, and/or column replacement is required. In some examples, performance parameter values that are at least three standard deviations from an average, expected, or prior value of the performance parameter may indicate that column evaluation, column remediation, and/or column replacement is required. In some examples, methods and systems according to the present disclosure may include recognizing potential dynamic seal errors and issuing a notification (e.g., an alarm). Such a notification may specify the degree of performance parameter deviation and/or indicate a source of a dynamic signal error (e.g., blocked columns, fouled detectors, and loose connections).

Systems of the present disclosure, such as, for example, chromatography systems including an automated fluid handling device may include one or more components (e.g., a processor) configured to process or access information corresponding to a column integrity for chromatographic column. For example, the system may compare one or more performance parameter values to one or more performance parameter value thresholds, performance parameter value threshold ranges, or historical performance parameter values. Based on the comparison, the system may determine that the column is suitable for use (e.g., has sufficient column integrity) or the system may determine that the column is not suitable for use (e.g., does not have sufficient column integrity). The system may generate an indication, such as a notification, an element of a graphical user interface, a report, or the like, that provides information to a user on the suitability of the column for use. In one example, an indication may include some type of notification that the chromatographic column is not suitable for use (e.g., re-use).

Chromatography systems used to implement the methods described herein may include, or be in communication with, a library of chromatographic column profiles, where each profile is associated with a specific chromatographic column. Each profile may include column identifiers, such as a reference or identification number, a chromatography media type, size dimensions, and/or a location. Additionally each profile may include one or more types of data indicative of a history of the associated column. For example, a profile may include a pre-use assessment protocol developed for the column (e.g., values for n, z, and/or b). Column profiles may include a record of data structures (e.g., first data structures, second data structures, and/or TPRD) previously generated using the column. Column profiles may include transition functions that were previously developed using the data structures generated using the column. For example, a column profile may include the values of coefficients of a transition function. Column profiles may include values of performance parameters that were previously generated for the column (e.g., a history of performance parameters generated from prior pre-use assessments). In addition or alternatively, column profiles may include previous determinations regarding the whether the column was acceptable for re-use. For example, if a pre-use assessment of a column generates a value of a performance parameter, and that value indicates that the column can be reused, the column profile associated with the column may indicate the performance parameter value and/or that the column was determined to be acceptable for reuse. Column profiles may include one or more dates associated with the column, such as, for example, dates of prior pre-use assessments or other chromatography operations conducted using the column.

Systems of the present disclosure may be configured to update column profiles as additional information is generated. For example, chromatography systems may be configured to manage the operations of an automated fluid handling system to conduct a pre-use assessment of a column. The chromatography system may additionally generate a performance parameter value associated with the column integrity of the column, as described herein. The chromatography system may update the column profile associated with the column as the pre-use assessment is conducted and/or as the performance parameter value is generated. In addition or alternatively, a set of column profiles associated with a set of chromatographic columns may be updated after the chromatography system conducts a pre-use assessment and generates performance parameter values for each column of the set of chromatographic columns. For example, a chromatography system may generate performance parameter values, and other data generated during a pre-use assessment, for each column of a set of chromatographic columns. The chromatography system may then be configured to convert the data generated during the pre-use assessment into one or more tables, charts, and/or into a format that can be appended or merged into an existing column profile.

As performance parameters are generated and column profiles are updated, one or more charts may be generated that show performance parameter values plotted against the date (or time elapsed) for a column or set of columns. The charts may provide a visual representation of one or more performance parameters associated with a column integrity, and the changes in the performance parameter over time. The charts may be quickly viewable, and may be readily interpretable from a visual standpoint.

### EXAMPLES

### Example 1

Pre-use assessments were conducted for eight 600 μL chromatographic columns (i.e., columns 1, 2, 3, 4, 5, 6, 7, and 8) in parallel using a chromatography system including an automated fluid handling device. The columns included a Protein A chromatography resin. Prior to the pre-use assessment, four column volumes of deionized water were passed through each column. The pre-use assessment included introducing four column volumes of a solution comprising 5 vol. % acetone into each column. Twelve fractions of the eluate of each column were collected in a 96-well plate. The absorbance of light having a wavelength of 275 nanometers was measured for each collected fraction.

For each column, the absorbance measurements were used to generate a first data structure, and a fitting algorithm was used to generate a transition function based on the first data structure. For each column, a second data structure was generated based on the transition function, and a transition plot was generated based on the data structures and transition function. Each transition plot included the absorbance measurements, the transition function, and other transition plot-related data (TPRD). The transition plots for columns 1, 2, 3 and 4 are superimposed upon each other and shown in FIG. 5A. The transition plots for columns 2, 5, 6, 7, and 8 are superimposed upon each other and are shown in FIG. 5B. The plots of FIGS. 5A and 5B include absorbance measurements and transition functions for each column.

After the second data structures were generated, a first transition analysis was performed for each column, based on the first and second data structures, to generate values for performance parameters (e.g., NG-HETP and skew) corresponding to each column. The generated performance parameters are shown in FIGS. 6A, 6B, 7A, and 7B, and are discussed below. As discussed below, the performance parameter values generated during the first transition analyses of the set of eight columns indicated that each column was capable of use.

After the pre-use assessments for the eight chromatographic columns were conducted, a chromatography operation was performed on each column. The chromatography operation included a high-flow rate event. A second pre-use assessment was performed on each of the eight chromatographic columns to determine if the high-flow rate event impacted the column integrity of any of the columns in the set of eight columns.

Prior to the second pre-use assessment, four column volumes of deionized water were passed through each column. The second pre-use assessment included introducing four column volumes of a solution comprising 5 vol. % acetone into each column. Twelve fractions of the eluate of each column were collected in a 96-well plate. The absorbance of light having a wavelength of 275 nanometers was measured for each collected fraction.

The absorbance measurements recorded during the second pre-use assessment were used to generate a third data structure, and a fitting algorithm was used to generate a transition function based on the third data structure. For each column, a fourth data structure was generated based on the transition function, and a transition plot was generated based on the data structures and transition function. Each transition plot included the absorbance measurements, the transition function, and other TPRD. The transition plots for columns 1, 2, 3 and 4 are superimposed upon each other and shown in FIG. 6A. The transition plots for columns 2, 5, 6, 7, and 8 are superimposed upon each other and are shown in FIG. 6B. The plots of FIGS. 6A and 6B include absorbance measurements and transition functions for each column.

After the fourth data structures were generated, a second transition analysis was performed for each column, based on the third and fourth data structures, to generate values for performance parameters (e.g., NG-HETP and skew) corresponding to each column. The generated performance parameters are shown in FIGS. 6A, 6B, 7A, and 7B, and are discussed below. As shown in FIG. 7B, some skew values generated during the second transition analysis of each column were multiple standard deviations below the mean. Accordingly, it was determined that at least one of the columns in the set of eight columns was not suitable for use. Based on the determination that one or more columns in the set were not suitable for use, the set of columns were replaced with eight new columns.

A third pre-use assessment was performed on each column of the new set of columns. Prior to the third pre-use assessment, four column volumes of deionized water were passed through each column. The second pre-use assessment included introducing four column volumes of a solution comprising 5 vol. % acetone into each column. Twelve fractions of the eluate of each column were collected in a 96-well plate. The absorbance of light having a wavelength of 275 nanometers was measured for each collected fraction.

The absorbance measurements recorded during the third pre-use assessment were used to generate a fifth data structure, and a fitting algorithm was used to generate a transition function based on the fifth data structure. For each column, a sixth data structure was generated based on the transition function. After the fourth data structures were generated, a third transition analysis was performed for each column, based on the fifth and sixth data structures, to generate values for performance parameters (e.g., NG-HETP and skew) corresponding to each new column.

As previously described, systems of the present disclosure may monitor, record, and/or track data structures, performance parameters, column integrity determinations, or a combination thereof, for chromatographic columns. Systems may generate one or more plots that summarize changes in performance parameters for one or more columns. Examples of such plots are shown in FIGS. 6A, 6B, 7A, and 7B.

The NG-HETP values calculated during the first, second, and third transition analyses for columns 1-8 are shown in FIGS. 6A and 6B. FIG. 6A shows the NG-HETP values for columns 1, 2, 3, and 4. FIG. 6B shows the NG-HETP values for columns 2, 5, 6, 7, and 8. Still referring to FIGS. 6A and 6B, run date 1 corresponds to the NG-HETP values generated from the first transition analysis, run date 2 corresponds to the NG-HETP values generated from the second transition analysis, and run date 3 corresponds to the NG-HETP values generated from the third transition analysis.

The skew values calculated during the first, second, and third transition analyses for columns 1-8 are shown in FIGS. 7A and 7B. FIG. 7A shows the skew values for columns 1, 2, 3, and 4. FIG. 7B shows the skew values for columns 2, 5, 6, 7, and 8. Still referring to FIGS. 7A and 7B, run date 1 corresponds to the skew values generated from the first transition analysis, run date 2 corresponds to the skew values generated from the second transition analysis, and run date 3 corresponds to the skew values generated from the third transition analysis.

Referring to FIGS. 6A, 6B, 7A, and 7B, subsequent to the high-flow rate event, changes in standard deviation for the skewness were greater than changes in standard deviation in NG-HETP. In some instances, skew may be impacted by changes in column integrity more appreciably than NG-HETP, particularly if the change in column integrity can be attributed to changes in axial or longitudinal dispersion of media within the column.

### Example 2

A chromatography operation was performed on eight chromatographic columns (i.e., columns 1, 2, 3, 4, 5, 6, 7, and 8) in parallel using a chromatography system including an automated fluid handling device. Each column had a total column volume of 600 μL and included an Protein A affinity media comprising sepharose. The chromatography operation included a first mobile phase comprising 20 mM acetic acid and a second mobile phase comprising 0.5 M acetic acid. The chromatography operation including passing three column volumes of the first mobile phase, followed by two column volumes of the second mobile phase, at a flow rate of 0.709 microliters per second. The chromatography operation was performed eleven times on the eight columns in parallel, for a total of 88 chromatography runs. FIG. 8A shows an overlay of chromatograms generated from the 88 chromatography runs. The chromatogram overlay shown in FIG. 8A may be used to qualitatively assess the chromatographic integrity of one or more columns. The legend in FIG. 8A indicates which chromatograms correspond to which columns. For example, all chromatograms generated from the first column are denoted by dashed line and open circle markers and all chromatograms generated from the second column are denoted by solid line and open square markers. Still referring to FIG. 8A, a qualitative assessment of the chromatography overlay can provide indications that one or more columns have a reduced column integrity. An elution peak shoulder at approximately 2.5-3 column volumes for chromatograms generated from column 7 were observed.

Chromatography systems of the present disclosure may be configured to generate chromatogram overlays including chromatograms generated from multiple parallel runs of a plurality of columns, such as the overlay shown in FIG. 8A. In addition or alternatively, the chromatography systems can be configured to isolate one or more columns and/or one or more run dates from the chromatography overlay. For example, when a column appears qualitatively to have reduced column integrity, further information may be gathered regarding chromatograms generated from that column.

Referring to FIG. 8B, chromatograms from column 4 were isolated and displayed from the chromatography overlay of FIG. 8A. Referring to FIG. 8C, chromatograms from column 7 were isolated and displayed from the chromatography overlay of FIG. 8A. By comparing the chromatograms between columns 4 and 7, it can be observed that the chromatograms generated from column 7 show an elution peak shift (e.g., an elution peak shoulder) at approximately 2.5-3 column volumes. The system can also identify the run dates of each chromatogram (e.g., when a user moves a cursor over a chromatogram line). The identification of the run dates of each chromatogram can inform trends in column integrity. For example, referring to FIG. 8C, the chromatograms that included an elution peak shift were run at a later run date than the chromatograms that are consistent with those generated from other columns. This information can be used to determine when column integrity was negatively impacted, and potential causes of the loss of column integrity.

Performance parameters were also recorded and monitored for the eleven parallel runs of the eight columns. Referring to FIG. 9, the recorded NG-HETP for all eight columns during three of the different chromatography runs are displayed. Run Date 1 of FIG. 9 corresponds to a transition analysis conducted with the new chromatographic columns, Run Date 2 of FIG. 9 corresponds to a transition analysis conducted before a high flow rate event (e.g., a chromatography process including a high rate of flow), and Run Date 3 of FIG. 9 corresponds to a transition analysis conducted after the high flow rate event. At run date 3, column 4 was indicated to have a NG-HETP value that is more than three standard deviations above the mean.

### Example 3

FIG. 10 depicts an exemplary column integrity assessment dashboard 1000, according to aspects of the present disclosure. As shown in FIG. 10, the dashboard 1000 can include a window console 1004. Selection of certain options, or combinations of options, can cause the dashboard 1000 to display one or more modules within window console 1004. For example, dashboard 1000 may display a transition plot module 1050, a data table module 1060, and/or a transition analysis module 1070 within window console 1004.

Transition plot module 1050 may include one or plots, such as, for example, one or more chromatograms. In the illustrated example, data points 1052 corresponding to absorbance measurements and transition functions 1054 for a group of eight chromatographic columns are displayed in the transition plot module 1050. Alternatively, the dashboard 1000 may provide for the selection of a select single column which may cause data points 1052 corresponding to absorbance measurements and a transition function 1054 for a single column to be displayed within transition plot module 1050.

Data table module 1060 may include information related to one or more column integrity assessments, data structures, transition functions, performance parameters, or other properties measured or determined as part of a column integrity assessment. For example, a table displayed in data table module 1060 may include a row 1064 corresponding to each selected chromatographic column. Each column 1062 of the table displayed within data table module 1060 may information regarding one or more properties (e.g., column integrity assessments, data structures, transition functions, performance parameters) for the selected columns. As shown, exemplary properties displayed within data table module 1060 may include M0 (the first moment), M1 (the second moment), M2 (the third moment), sigma (standard deviation), NGHETP, skew, and GHETP.

Transition analysis module 1070 may include one or more charts, tables, or other configurations of data that show performance parameters for one or more selected chromatographic columns. For example, dashboard 1000 may display a chart 1072 that shows changes in performance parameter values over time, for a set of selected columns, within transition analysis module 1070. In the illustrated example, chart 1072 displays values of NG-HETP for eight selected columns, across three different run dates. Chart 1072 may include a legend 1074 identifying the chromatographic column that correspond to the plotted performance parameters.

In addition or alternatively, the transition analysis module 1070 may include column use/re-use indicators corresponding to particular results that may be generated from the assessment of performance parameter values, as described herein. For example, transition analysis module 1070 may include one or more indicators 1076a, 1076b that provide a visual marker, text-based notification, and/or other means of conveying information regarding whether a selected column is suitable for use (e.g., re-use). One such indicator 1076a shown in FIG. 10 provides a visual marker corresponding to a performance parameter value that indicates a column is not suitable for use. Another such indicator 1076b shown in FIG. 10 is a text-based alert that indicates a column is not suitable for use.

A system including dashboard 1000, or in communication with dashboard 1000, may include a library of column profiles, as described herein. Dashboard 1000 may use data from the library of column profiles to populate one or more charts, tables, and/or plots within window console 1004. Dashboard 1000 may allow a user to edit, modify, write, delete, and/or reorganize data related to column profiles (e.g., the contents of the library of column profiles). Advantageously, changes made to column profiles may be made while information regarding performance parameters, column integrity, and/or re-use indications are displayed.

The many features and advantages of the present disclosure are apparent from the detailed specification, and thus, it is intended by the appended claims to cover all such features and advantages of the present disclosure that fall within the true spirit and scope of the disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure

The present disclosure is further described by the following non-limiting items.

Item 1. A method for assessing chromatographic column integrity, the method comprising:
introducing acetone into a chromatographic column;
measuring absorbance values of an eluate of the chromatographic column;
generating a first data structure based on the absorbance values;
implementing a fitting algorithm based on the first data structure to generate a transition function;
generating a second data structure based on the transition function;
generating a transition plot based on the first and second data structures, wherein the transition plot includes transition plot-related data; and
generating a value of a performance parameter based on the transition plot-related data.

Item 2. The method of item 1, wherein the chromatographic column has a column volume of about 50 μL to about 600 μL.

Item 3. The method of item 1 or 2, wherein the chromatographic column is a first chromatographic column, the value of the performance parameter corresponds to a column integrity of the first chromatographic column, and the method further comprises simultaneously generating a second value of the performance parameter corresponding to a column integrity of a second chromatographic column.

Item 4. The method of any one of items 1 to 3, wherein the performance parameter is non-Gaussian height equivalent of a theoretical plate (NG-HETP).

Item 5. The method of any one of items 1 to 4, wherein the performance parameter is a skew.

Item 6. The method of any one of items 1 to 5, wherein the transition function includes a cumulative distribution function.

Item 7. The method of any one of items 1 to 6, wherein the transition function includes a sigmoid function.

Item 8. The method of item 7, wherein the sigmoid function is a five-parameter sigmoid function.

Item 9. A method of developing a pre-use assessment protocol, the method comprising:
performing a first chromatography operation using a first chromatographic column, the first chromatography operation including:
   introducing a first volume of tracing agent to the chromatographic column, wherein the first volume of tracing agent includes a first concentration of the tracing agent;
   measuring a first set of absorbance values of an eluate of the first chromatography operation;
   generating a first data structure based on the first absorbance values;
   implementing a first fitting algorithm based on the first data structure to generate a first transition function; and
   determining a first coefficient of correlation corresponding to the first transition function;
performing a second chromatography operation using the first chromatographic column or a second chromatographic column, the second chromatography operation including:
   introducing a second volume of tracing agent to the chromatographic column, wherein the second volume of tracing agent includes a second concentration of the tracing agent;
   measuring a second set absorbance values of an eluate of the second chromatography operation, wherein the second set of absorbance values includes a different number of absorbance values than the first set of absorbance values;
   generating a second data structure based on the second absorbance values;
   implementing a second fitting algorithm based on the second data structure to generate a second transition function; and
   determining a second coefficient of correlation corresponding to the second transition function;
comparing the first coefficient of correlation to the second coefficient of correlation; and
based on the comparison of the first coefficient of correlation to the second coefficient of correlation, determining a third volume of tracing agent, a third concentration of the tracing agent, and a sample size of absorbance measurements.

Item 10. The method of item 9, wherein third volume is equal to the first or the second volume, the third concentration is equal to the first or the second concentration, and/or the sample size of absorbance measurements is equal to the number of absorbance measurements in the first or the second set of absorbance measurements.

Item 11. The method of items 9 or 10, wherein tracing agent is acetone.

Item 12. The method of any one of items 9 to 11, further comprising performing a third chromatography operation, the third chromatography operation including:
introducing the third volume of the tracing agent into the first chromatographic column, the second chromatographic column, or a third chromatographic column;
measuring a third set of absorbance values of an eluate of the third chromatography operation, wherein the third set of absorbance measurements includes a number of values equal to the sample size of absorbance measurements;
generating a third data structure based on the absorbance values;
implementing a third fitting algorithm based on the third data structure to generate a third transition function;
generating a fourth data structure based on the third transition function;
generating a transition plot based on the third and fourth data structures, wherein the transition plot includes transition plot-related data; and
generating a value of a performance parameter based on the transition plot-related data.

Item 13. The method of any one of items 9 to 12, wherein the first chromatographic column has a column volume (CV) of about 50 μL to about 600 μL.

Item 14. The method of item 13, wherein the first volume of tracing agent is about 2 CV to about 5 CV and the second volume of tracing agent is about to 2 CV to about 5 CV.

Item 15. The method of any one of items 9 to 13, wherein the first concentration of tracing agent is about 0.1 vol. % to about 2 vol. % and the second concentration of tracing agent is about 3 vol. % to about 5 vol. %.

Item 16. A system for assessing chromatographic column integrity, the system comprising:
a chromatographic column;
an automated fluid handling device;
a detector;
a processor; and
a non-transitory computer readable media comprising instructions which, when executed by the processor, causes the processor to perform operations, the operations comprising:
   introducing, with the automated fluid handling device, acetone into the chromatographic column;
   measuring, with the detector, an absorbance of an eluate of the chromatographic column;
   generating, with the processor, a first data structure based on the measured absorbance;
   implementing, with the processor, a fitting algorithm based on the first data structure to generate a transition function;
   generating, with the processor, a second data structure based on the transition function;
   generating, with the processor, a transition plot based on the first and second data structures, wherein the transition plot includes transition plot-related data (TPRD); and
   analyzing, with the processor, the transition plot-related data (TPRD) to generate a value of a performance parameter.

Item 17. The system of item 16, wherein the performance parameter corresponds to a column integrity of the chromatographic column.

Item 18. The system of item 16 or 17, wherein the performance parameter includes a non-Gaussian height equivalent of a theoretical plate (NG-HETP) or a skew.

Item 19. The system of any one of items 16 to 18, wherein the chromatographic column has a column volume of about 50 μL to about 600 μL.

Item 20. The system of any one of items 16 to 19, wherein the chromatographic column is a first chromatographic column, the system further comprises a second chromatographic column, the value of the performance parameter is a first value of the performance parameter, and the operations further comprise generating a second value of the performance parameter; and
wherein the first value of the performance parameter corresponds to a column integrity of the first chromatographic column and the second value of the performance parameter corresponds to a column integrity of the second chromatographic column.

Those skilled in the art will appreciate that the conception upon which this disclosure is based may readily be used as a basis for designing other methods and systems for carrying out the several purposes of the present disclosure. Accordingly, the claims are not to be considered as limited by the foregoing description.

What is claimed is:

1. A method for assessing chromatographic column integrity, the method comprising:
introducing acetone into a chromatographic column;
measuring absorbance values of an eluate of the chromatographic column;
generating a first data structure based on the absorbance values;
implementing a fitting algorithm based on the first data structure to generate a transition function;
generating a second data structure based on the transition function;
generating a transition plot based on the first and second data structures, wherein the transition plot includes transition plot-related data; and
generating a value of a performance parameter based on the transition plot-related data.

2. The method of claim 1, wherein the chromatographic column has a column volume of about 50 μL to about 600 μL.

3. The method of claim 1, wherein the chromatographic column is a first chromatographic column, the value of the performance parameter corresponds to a column integrity of the first chromatographic column, and the method further comprises simultaneously generating a second value of the performance parameter corresponding to a column integrity of a second chromatographic column.

4. The method of claim 1, wherein the performance parameter is non-Gaussian height equivalent of a theoretical plate (NG-HETP).

5. The method of claim 1, wherein the performance parameter is a skew.

6. The method of claim 1, wherein the transition function includes a cumulative distribution function.

7. The method of claim 1, wherein the transition function includes a sigmoid function.

8. The method of claim 7, wherein the sigmoid function is a five-parameter sigmoid function.

9. A method of developing a pre-use assessment protocol, the method comprising:
performing a first chromatography operation using a first chromatographic column, the first chromatography operation including:
introducing a first volume of tracing agent to the chromatographic column, wherein the first volume of tracing agent includes a first concentration of the tracing agent;
measuring a first set of absorbance values of an eluate of the first chromatography operation;
generating a first data structure based on the first absorbance values;
implementing a first fitting algorithm based on the first data structure to generate a first transition function; and
determining a first coefficient of correlation corresponding to the first transition function;
performing a second chromatography operation using the first chromatographic column or a second chromatographic column, the second chromatography operation including:
introducing a second volume of tracing agent to the chromatographic column, wherein the second volume of tracing agent includes a second concentration of the tracing agent;
measuring a second set absorbance values of an eluate of the second chromatography operation, wherein the second set of absorbance values includes a different number of absorbance values than the first set of absorbance values;
generating a second data structure based on the second absorbance values;
implementing a second fitting algorithm based on the second data structure to generate a second transition function; and
determining a second coefficient of correlation corresponding to the second transition function;
comparing the first coefficient of correlation to the second coefficient of correlation; and
based on the comparison of the first coefficient of correlation to the second coefficient of correlation, determining a third volume of tracing agent, a third concentration of the tracing agent, and a sample size of absorbance measurements.

10. The method of claim 9, wherein third volume is equal to the first or the second volume, the third concentration is equal to the first or the second concentration, and/or the sample size of absorbance measurements is equal to the number of absorbance measurements in the first or the second set of absorbance measurements.

11. The method of claim 9, wherein tracing agent is acetone.

12. The method of claim 9, further comprising performing a third chromatography operation, the third chromatography operation including:
introducing the third volume of the tracing agent into the first chromatographic column, the second chromatographic column, or a third chromatographic column;
measuring a third set of absorbance values of an eluate of the third chromatography operation, wherein the third set of absorbance measurements includes a number of values equal to the sample size of absorbance measurements;
generating a third data structure based on the absorbance values;
implementing a third fitting algorithm based on the third data structure to generate a third transition function;
generating a fourth data structure based on the third transition function;
generating a transition plot based on the third and fourth data structures, wherein the transition plot includes transition plot-related data; and
generating a value of a performance parameter based on the transition plot-related data.

13. The method of claim 9, wherein the first chromatographic column has a column volume (CV) of about 50 μL to about 600 μL.

14. The method of claim 13, wherein the first volume of tracing agent is about 2 CV to about 5 CV and the second volume of tracing agent is about to 2 CV to about 5 CV.

15. The method of claim 9, wherein the first concentration of tracing agent is about 0.1 vol. % to about 2 vol. % and the second concentration of tracing agent is about 3 vol. % to about 5 vol. %.

16. A system for assessing chromatographic column integrity, the system comprising:
a chromatographic column;
an automated fluid handling device;
a detector;
a processor; and
a non-transitory computer readable media comprising instructions which, when executed by the processor, causes the processor to perform operations, the operations comprising:
introducing, with the automated fluid handling device, acetone into the chromatographic column;
measuring, with the detector, an absorbance of an eluate of the chromatographic column;
generating, with the processor, a first data structure based on the measured absorbance;
implementing, with the processor, a fitting algorithm based on the first data structure to generate a transition function;
generating, with the processor, a second data structure based on the transition function;
generating, with the processor, a transition plot based on the first and second data structures, wherein the transition plot includes transition plot-related data (TPRD); and
analyzing, with the processor, the transition plot-related data (TPRD) to generate a value of a performance parameter.

17. The system of claim 16, wherein the performance parameter corresponds to a column integrity of the chromatographic column.

18. The system of claim 16, wherein the performance parameter includes a non-Gaussian height equivalent of a theoretical plate (NG-HETP) or a skew.

19. The system of claim 16, wherein the chromatographic column has a column volume of about 50 μL to about 600 μL.

20. The system of claim 16, wherein the chromatographic column is a first chromatographic column, the system further comprises a second chromatographic column, the value of the performance parameter is a first value of the performance parameter, and the operations further comprise generating a second value of the performance parameter; and
wherein the first value of the performance parameter corresponds to a column integrity of the first chromatographic column and the second value of the performance parameter corresponds to a column integrity of the second chromatographic column.
